(19) United States
(12) Patent Application Publication
(10) Pub. No.: US 2014/0345562 A1
(43) Pub. Date: Nov. 27, 2014

(54) Single-stage and three-stage internal combusion rotary engines

(71) Applicant: Abraham Hugo Horstin, Thousand Oaks, CA (US)

(72) Inventor: Abraham Hugo Horstin, Thousand Oaks, CA (US)

(73) Assignee: ABRAHAM HUGO HORSTIN, Thousand Oaks, CA (US)

(21) Appl. No.: 13/986,671

(22) Filed: May 23, 2013

(51) Int. Cl. F02B 53/00

(52) U.S. Cl. CPC F02B 53/00
USPC 123/215

(57) ABSTRACT

This is a description of a single-stage engine having a cylindrical rotor with four curved blades attached by means of free rotating rods. The curved blades have extended, half-round knobs on opposite sides, aligned with the top surface that fit in the extended hemispherical grooves on the interior side-walls of the housing. The egg-shaped housing facilitates the compression and exhaust cycles. The two housing halves are joined together at the center.

The three-stage engine comprises a compressor, which feeds air to a combustor for fuel injection, combustion and expansion of gases which rotate the rotor and generate torque. The afterburner receives the combusted gases from the combustor for secondary combustion and exhaust. Each unit consists of a cylindrical housing joined together on a common axis and a rotor mounted in an eccentric position of the housing sidewalls. The blades are similarly assembled as above.

### CROSS REFERENCE TO RELATED APPLICATIONS

U.S. Pat. No. 7,117,839 B2

Dated, Oct. 10, 2006

### FEDERALLY SPONSORED RESEARCH

Not applicable

### SEQUENCE LISTING OR PROGRAM

Not applicable

### BACKGROUND OF THE INVENTION

### Field of Invention

This invention relates to a single-stage and three-stage rotary internal combustion engine of the blade type.

The three-stage engine includes a compressor unit, combustor unit and afterburner unit.

### INTRODUCTION

A Single-stage and a Three-stage Rotary Internal Combustion Engines used as a prime mover are discussed. The internal parts of the Single-stage and the Three-stage engine are identical except for the shape of the Housings. The Three-stage engine has circular Housings; the Single-stage engine has an oval or egg shaped Housing to optimize the compression and exhaust cycle. The Housing halves are secured by bolts.

The Three-stage engine has a Compressor unit to feed compressed air to a Combustor unit for further compression. The Combustor has a means for fuel injection and ignition at a high degree of compression. The Combustor Rotor is driven by expansion of the combusted gases.

The Single-stage engine consists only of a Combustor and operates in a similar manner as the Three-stage engine Combustor. Referring to the Three-stage engine, an Afterburner unit receives the combusted gases and scavenged air from the Combustor unit for re-burning, generating additional work and expelling the exhaust gases.

Each unit of the three stages consists of a cylindrical Rotor that has internal and external splines for the Combustor unit, an internal spline for the Compressor unit, and an external spline for the Afterburner unit. The Rotors are interconnected by the splines, turn uni-directionally, and have an output end for continuously transmitting power. The Rotors are mounted in an eccentric position within the interior of the Housing, and are supported by the carrying side-walls of the Housing.

The cylindrical Rotor of the Single-stage engine with the egg-shaped Housing is mounted at the center position within the interior of the Housing, and is supported by the carrying side-walls of the Housing. Each Rotor for the Single-stage engine and the Three-stage engine accommodates multiple blades that move within the Rotor cut-outs.

The Single-stage engine Combustor and the Three-stage engine Compressor, Combustor and Afterburner units are each provided with four curved Blades that fit in the Rotor cut-outs and are connected at one end to the Rotors by means of round, free rotating rods. At the other end, the Blades are provided with extended half-round Knobs on opposite sides, aligned with their top-end surface. These extended half-round Knobs fit and slide in deep hemispherical grooves that act as a raceway on the interior side-walls of the Housing. The Grooves follow the contour of the interior periphery of the Housing, enabling the Blades to maintain contact with the interior walls, independent of the gas pressure or Rotor speed.

The Combustor unit for the Single-stage and the Three-stage engine has four chambers to create power: an intake chamber, a compression chamber, an ignition and combustion chamber, and an expansion and exhaust chamber. Each chamber is defined by the curved blade, the interior carrying side-walls of the Housing, the interior peripheral wall of the Housing and the outside cylindrical surface of the Rotor. The Compressor and Afterburner have also four chambers. The Single-stage engine egg-shaped Housing consists of two halves that are secured by fasteners at the center. Similarly, the Three-stage engine has split Housings. The Compressor, Combustor and Afterburner are assembled and secured by fasteners at the center of each Rotor, while the Rotors are interlinked by splines to form a common shaft turning the Rotors uni-directionally and at the same speed.

Both engines provide four cycles per revolution: the intake, the compression, the ignition and combustion, and the expansion and exhaust cycle. The Single-stage engine operates primarily at a lower compression ratio with internal spark ignition and fuel injection system. The Three-stage engine is adaptable to a variety of operating conditions and may be operated either as an internal spark ignition system with a lower compression ratio or as a diesel system with a high overall volume ratio and compressed ignition, incorporating fuel injection for both systems.

### BACKGROUND OF THE INVENTION

This invention relates to Single-stage and a Three-stage rotary internal combustion engines. The difference between the Single-stage and the Three-stage engine is the shape of the Housings. The Single-stage engine Combustor Housing is egg-shaped to facilitate the compression, ignition and combustion, and the exhaust cycle, while the internal components are identical for both engine types. The Three-stage combustion engine consists of a Compressor unit, Combustor unit and Afterburner unit. Each unit consists of a Housing with a circular bore and a cylindrical Rotor that transfers the spinning motion of the Rotor.

The Rotor of the Single-stage engine is mounted at the center of the internal egg-shaped Housing. The Rotors of the Three-stage engine are mounted in an eccentric position in the bore. For both configurations the Rotors are supported by the carrying side-walls of the Housing. The Rotors are equipped with four curved blades, mounted into the cut-out of the Rotors and held in place by free rotating shafts at one end and spaced ninety degrees apart. The other end of the blades are outfitted with extended half round Knobs on opposite sides, aligned with their top surface, which fit in extended hemispherical grooves in the side-walls of the Housing.

This invention is directed to a Single-stage and a Three-stage rotary Blade engine, with a central Rotor for the Single-stage and an eccentric Rotor for the Three-stage engine. Both configurations accommodate four curved blades, spaced ninety degrees apart, which fit in the cut-out of the Rotor. The Blades are attached to the Rotor by means of free rolling shafts. The other end of the Blade has knobs that extend into two deep hemispherical grooves at the periphery of the Housing.

The main features are as follows:

The Single-stage engine has a smooth egg-shaped internal Housing; a cylindrical Rotor is mounted in the center position with respect to the Housing's internal shape and is supported by the carrying side-walls of the Housing.

The Three-stage engine has cylindrical bores. Cylindrical Rotors are mounted in an eccentric position with respect to the Housing's bore and are supported by the carrying side-walls of the Housings.

Each Housing has a hemispherical concentric groove, with a depth of about the equivalent of once to twice the diameter of the groove. The groove is aligned with the interior Housing's peripheral wall. The grooves are provided on the two opposing side-walls and act as a guiding track for the Blades, by capturing their extended half round Knobs. The four curved Blades for each Rotor are mounted ninety degrees apart by free rolling rods on the Rotor cutouts. The extended Knobs of the Blades, guided by the Housing grooves are placed ahead of the connecting Rotor rods, in the direction of the rotation to provide for a smooth upward and downward Blade motion during Rotor rotation.

The power output is realized by the expanding gas in the combustor acting on the blades in any position that slide around the internal periphery of the Housings, resulting in Rotor torque. The four combustion processes per revolution result in a reduced differential pressure between the compression, ignition and combustion, and expansion chambers. Therefore, high sealing requirements between the Blades, the Housing sidewalls, and the Internal Peripheral Wall of the Housings are not required and this reduces friction between the Blades and Housing.

The approach provided in these engine designs will result in a compact, reliable, simply designed and easily manufactured Three-stage engine with high power output. This is particularly true for the Three-stage engine, which is clean burning, consumes less fuel, and has a high power output. This becomes clear from the analysis that follows.

### SUMMARY OF THE INVENTION

It is the primary objective of this invention to provide a Single-stage and a Three-stage rotary internal combustion engine of the pivoting sliding Blade type, that is simple in construction, robust in design, easy to manufacture, low in parts count, reliable in operation, compact in size, has a high power output; in particular for the Three-stage engine. The invention is clean burning with reduced harmful emissions.

Another object of the present invention is to provide water cooling of the Housing and Housing modules, and oil cooling and lubrication of moving parts.

Herein, the objects of this invention are realized by the following technical solutions. According to the invention a Single-stage and a Three-stage rotary internal combustion engine with pivoting and permanently guided sliding Blades is presented.

The Single-stage rotary internal combustion engine consists of a Combustor unit that incorporates a compressing portion, a working ignition and expansion portion, and an exhaust portion.

The Three-stage internal combustion engine (schematic shown in FIG. 3) consists of a compressor unit providing scavenge and pre-charged air, a combustor unit that incorporates a compressing portion, a working ignition and expansion portion, an afterburner unit comprising a expansion and exhaust portion an ignition system and a cooling system.
A. The Single-stage internal combustion engine has an egg-shaped Housing that is also the Combustor. The Rotor is mounted at the center, and is provided with four Blades, placed ninety degrees apart in the cut-outs of the Rotor and attached by means of free rotating rods. The curved Blades that pivot around the rods are provided with extended half-round Knobs at opposite sides at the top, aligned with the top surface, and are guided and suspended in the deep hemispherical grooves with a depth to fit the extended half-round Knobs in both interior side-walls of the Housing. The Rotor is provided with a hollow core to allow oil flow for lubrication and cooling. A spark plug and a fuel injector, needed for ignition of the engine are placed in the peripheral wall of the Housing at the point of the highest combustion. The Combusted and expanding gases move the Blades in the direction of the exhaust port, thus spinning the Rotor.
B. The Three-stage engine working portion comprises at least a compressor unit, a combustor unit and an afterburner unit. An output Rotor consists of a combustor rotor and afterburner rotor. Each Rotor has four curved blades, spaced ninety degrees apart. The construction of the attachment to the Rotor and the method of guiding and suspending in the deep hemispherical grooves in both interior side-walls of the Housing are identical to that of the Single-stage engine, except that the Housings internally are cylindrical.
C. The compressor entity consists of two Housing halves, joined together at the section with the cylindrical bore and a splined cylindrical Rotor with a hollow core, which is mounted in an eccentric position within the Housing and supported by the interior carrying walls. The Rotor has four Blades, spaced ninety degrees apart similar to the Single-stage engine configuration, with similar attachments and guided in the Housing. The Rotor rotates about its axis; the curved Blades extend and retract around their pivot, thus forming induction and compression chambers within the Housing interior side-walls, the interior periphery and the outside surface of the cylindrical Rotor. An inlet port through the housings peripheral wall is provided on the upstream side in the induction chamber. An outlet port in the compressing portion of the chamber is placed on the downstream side through the Housing's peripheral wall leading to the inlet port of the combustion unit.
D. The combustor unit consists of two Housing Halves, joined together at the middle with a cylindrical bore. A cylindrical Rotor, splined on both ends, has a hollow core. The Rotor is placed in an eccentric position and is supported by the carrying side-walls of the Housing. The Rotor with the four Blades is constructed in a similar method as the Single-stage engine, including the suspension and guiding of the Blades in the deep hemispherical grooves in both interior side-walls of the Housing. An inlet passage linked to the Compressor is installed through the peripheral wall of the Housing to allow entrance of the pre-compressed air for further compression, ignition, combustion and expansion. The expanded hot gases act on the Blades' surfaces and Rotor cut-outs' flat surfaces resulting in Rotor torque, simultaneously combining the interlinked Rotors and torques of the Compressor and Afterburner.
   Two spark plugs for spark ignition or two glow plugs for cold engine diesel ignition and two fuel injectors needed for: the ignition of the engine are placed in the peripheral wall of the Combustor at the point of the highest compression. The combusted and Expanding gases move the Blades in the direction of the exhaust port thus spinning the Rotor. The expansion stroke in the Combustor is approximately equivalent to one and one and a half the compression stroke, adding to the efficiency of the engine's operating cycle. Scavenged air aides in expelling residual exhaust gases. An exhaust outlet port is located in the peripheral wall of the Housing in the working portion of the combustor. The space is defined by the Housing's peripheral wall, the outside surface of the cylindrical Rotor, the upstream and downstream blades and the interior side-walls of the Housing. The combusted and expanding gases move in the direction of the rotation to the outlet port and pass through the drilled transfer hole to the inlet port of the Afterburner.
   The Afterburner entity consists of two Housing halves joined together at the section with a cylindrical bore and a splined cylindrical Rotor, with a hollow core, which is mounted in an eccentric position within the Housing and supported by the interior carrying side walls. The Rotor has four Blades, spaced ninety degrees apart similar to the Single-stage engine configuration, with similar attachments and guided in the housing. The hollow core in the center of the shaft allows oil flow for lubrication and cooling. The exhaust gases and scavenged air from the Combustor unit enter the Afterburner through a drilled hole located in the Housing peripheral wall. Two glow plugs ignite fugitive hydro carbons for afterburning. The glow plugs are installed on the interior peripheral wall of the Housing in a position adjacent to the upstream side in the direction of rotation of the working portion of the chamber. The peripheral wall of the Housing is provided with an inlet port to expel afterburning gases.
   The operating volume formed by the Housing interior peripheral wall, the cylindrical Rotor's external surface, the Housing side walls, and the extended and compressed Blades is greater than the corresponding volume of the working portion of the Compressor. Operating volume in the Afterburner consists of heated and expanded exhaust gases and scavenged air from the Combustor.

The present invention has the following advantages because of the features described above.
1. Since for small engines simplicity and weight are important, the Single-stage engine conforms to this category.
2. Since the Three-stage engine has three stages, a Compressor to supercharge the air for work and scavenge in the Combustor; a Combustor with a larger expansion than compression stroke; and an Afterburner to complete the lean burning process of the Combustor exhaust gases, it achieves improved utilization of energy.
3. Since the eccentric Rotors are supported on opposite sides by the carrying side-walls of the Housing, and the Blades are pivoting on the freely rotating rods mounted on the Rotor and are guided and suspended at their top-end in the hemispherical grooves that have a depth of about twice the diameter of the half round Knobs, the resulting extension and retraction motion of the Blades is smooth and occurs without hesitation.
4. Since the eccentric Rotors have a hollow core and are interconnected by splines and communicate with each other, oil for lubrication and cooling is easily accommodated and reliability is increased.
5. Since, during afterburning of the exhaust gases, gas leaks and blowbacks from the Combustor are collected in the Afterburner for re-burning by means of a glow plug, additional power for efficiency and a reduction in polluting exhaust is achieved.

### DESCRIPTION OF THE DRAWINGS

The present invention is illustrated with drawings of the preferred embodiment. Following is a brief description of the drawings.

FIG. 1 is a cross-section of a single-stage engine

FIG. 1A is a cross-section of FIG. 1, exhibiting the Housing halves, secured by means of bolts in the center split including metallic spring seals.

FIG. 1B is a drawing of the torque diagram of FIG. 1, with the accompanying analysis sheets, to present the creation of operation and developed torque.

FIG. 2 is a cross-section of the three-stage engine, exhibiting the combined units of the Compressor, Combustor and Afterburner, interconnected by splines for the Rotors and the Housing halves secured by means of bolts at the center split and provided with metallic spring seals at the interfaces.

FIG. 3 is a schematic of the three-stage engine, showing the working procedure of the embodiment of this invention and the sequence of operation of the Compressor, Combustor and Afterburner units.

FIG. 4 is a drawing of the Combustor, showing the supercharged air inlet, compression and ignition, expansion and exhaust cycle.

FIG. 4A is a cross-section of FIG. 4, exhibiting the Housing haves secured by means of bolts and optional nuts at the center split, including metallic spring seals at the interfaces. The Rotor and the Blades attach to the Rotor by means of free rotating rods.

FIG. 4B is a drawing of the torque diagram of FIG. 4 with accompanying analysis sheets, to present the creation of operation and developed torque.

FIG. 4C is a drawing of the Torque diagram, with the Blades equipped with extended half round Knobs.

FIG. 4D is a drawing of the Torque diagram, where the Housing of the exhaust area is partially flat to facilitate the expulsion of exhaust gases.

FIG. 5 is a drawing of the combustor for a clockwise rotation of the Blades, with the accompanying analysis sheets.

FIG. 5A is a drawing of the Combustor for a clockwise rotation of the straight blades, with the accompanying analysis sheets. Both configurations are unable to create torque and power.

FIG. 6 is a drawing of the Compressor at thirty degrees right from the vertical centerline and the Torque diagram with the accompanying analysis sheets.

FIG. 6A is the similar Compressor drawing at thirty degrees left from the vertical centerline and the Torque diagram. The accompanying analysis sheet shows the variance at the different positions.

FIG. 6B is a drawing of the same Compressor with slightly longer Blades. It shows that the Blade should be constructed as long as possible to reduce side-load at start-up.

FIG. 7 is a drawing of the Afterburner showing the exhaust from the Combustor and the exhaust cycle.

FIG. 8 shows the various different Blade configurations that are adaptable for the compressor, Combustor or Afterburner and the Single-stage engine.

FIG. 9 is a typical view and cross-section of a Rotor that is used for any of the units. The Combustor has splines at both ends, both male and female, while the Compressor has a female spline at one end; the Afterburner has only a male spline at one end.

### DESCRIPTION OF THE EMBODIMENT

The primary objective of this invention is to illustrate the operation of the embodiment of a Single-stage and Three-stage rotary internal combustion engine of the Blade type.

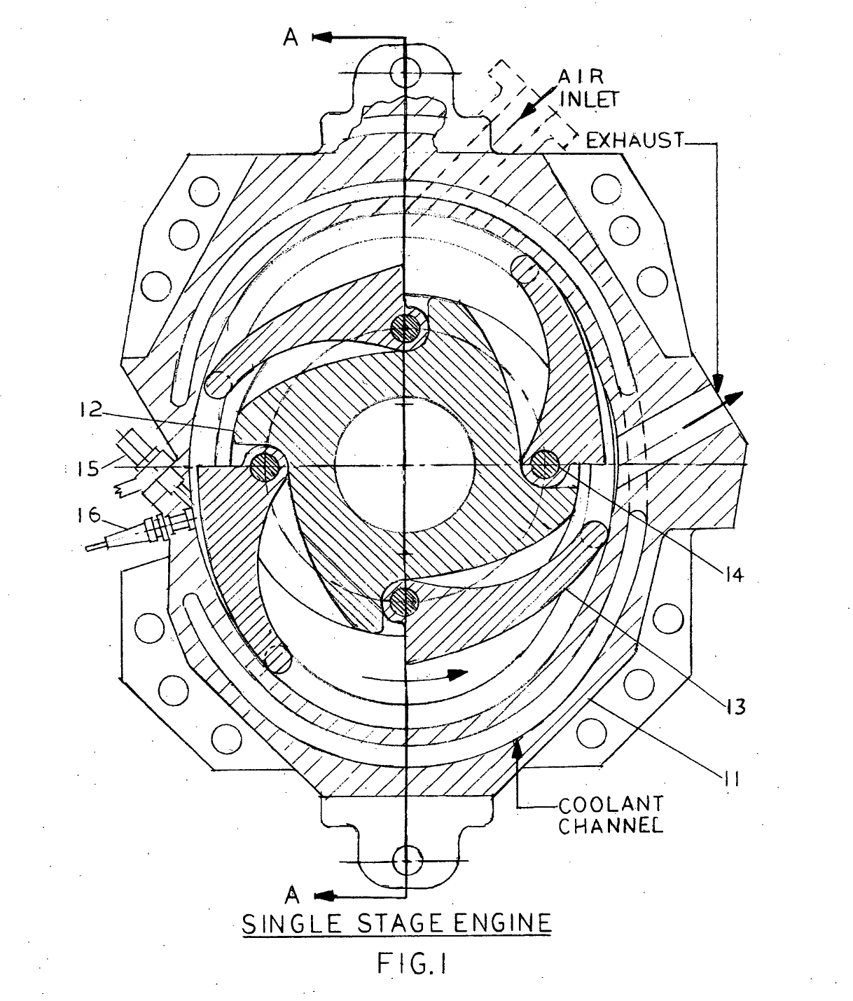

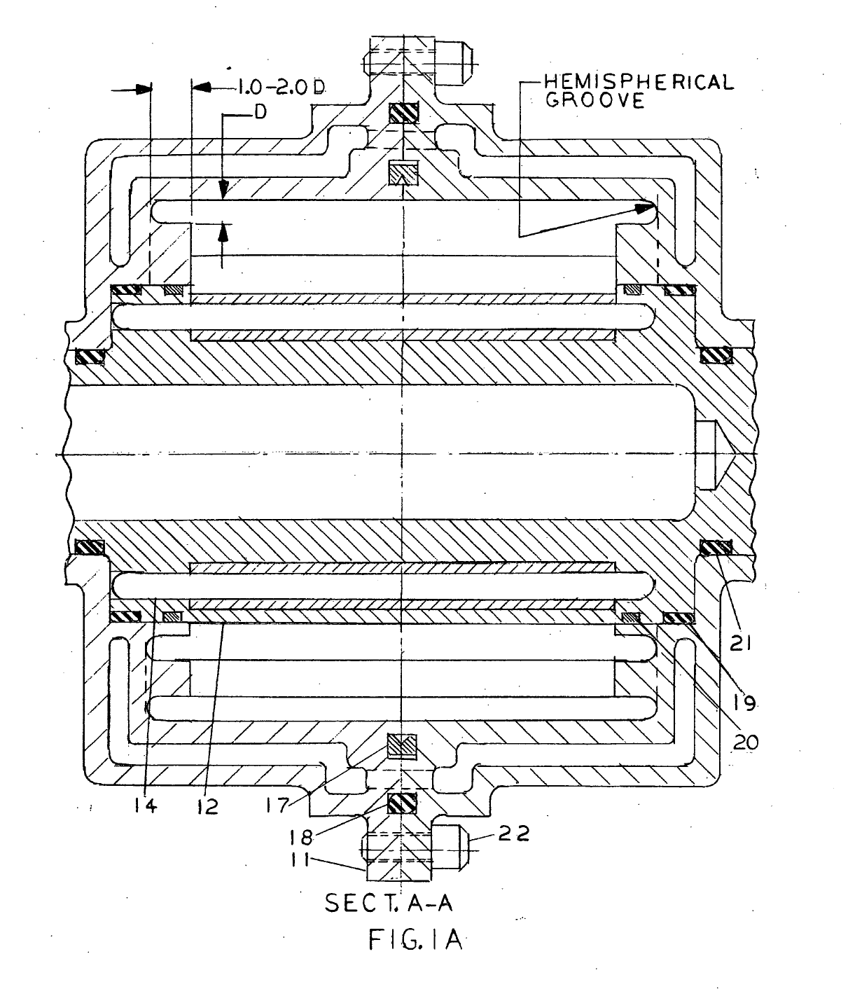

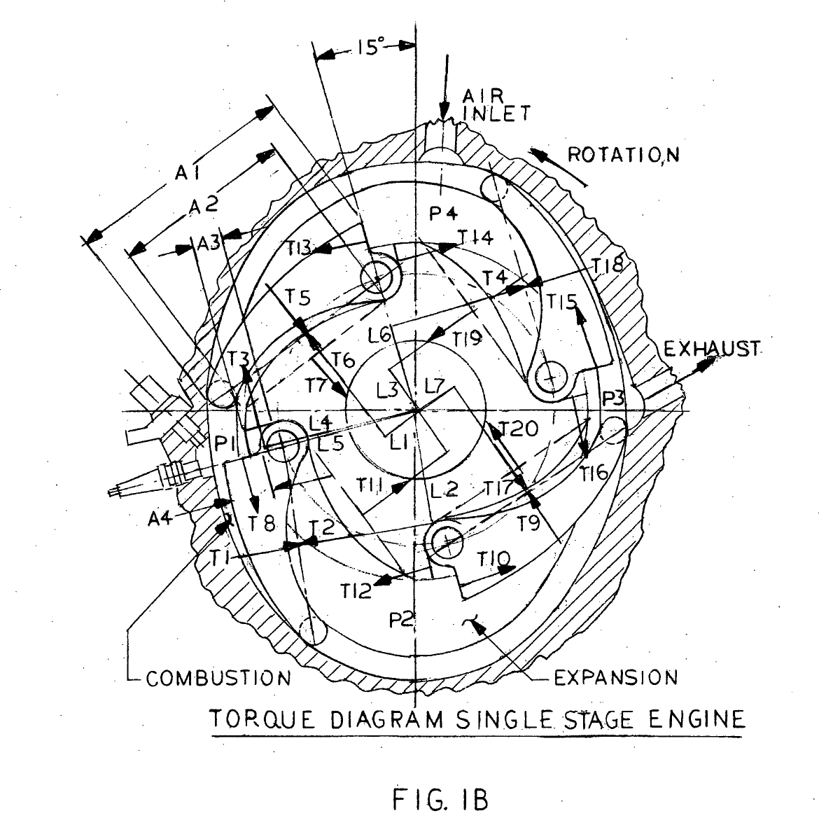

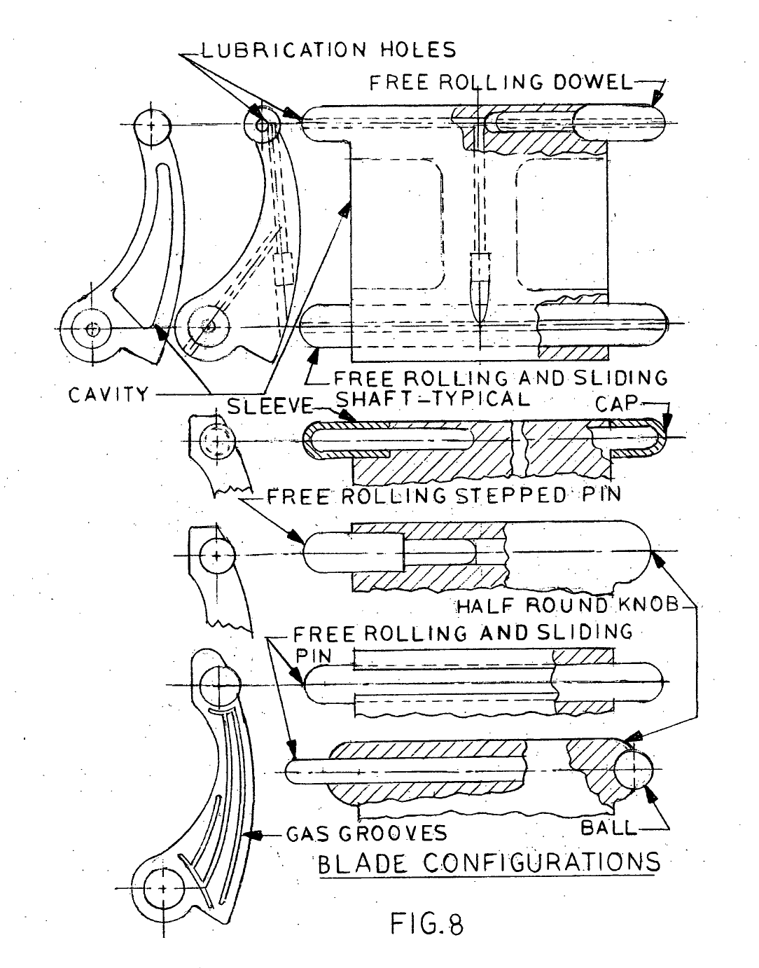

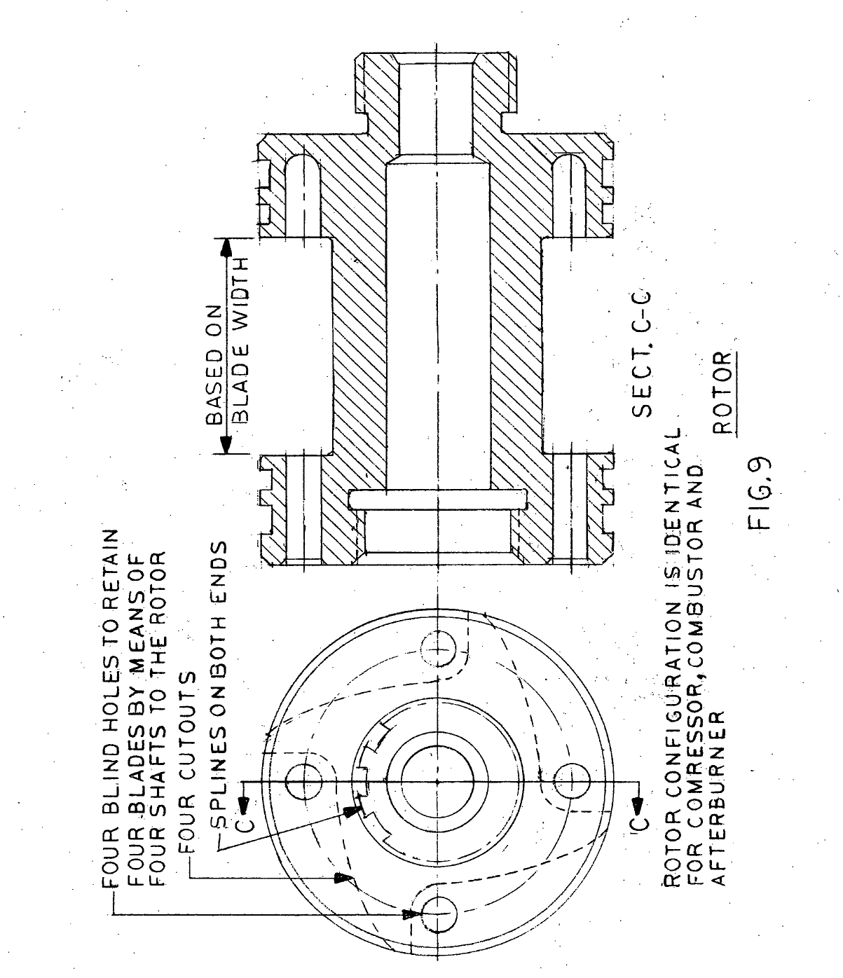

The Single-stage rotary combustion engine, exhibited in FIG. 1, FIG. 1A and FIG. 1B comprises oval or egg-shaped Housing halves 11 (shown in FIG. 1A), secured by bolts 22, and a cylindrical Rotor 12, installed at the center. The Rotor is constructed with four cut-outs (shown in FIG. 9), ninety degrees apart, in which four curved Blades 13 (shown in FIG. 1) are inserted that are connected to the Rotor 12 by means of round free rotating rods 14 (shown in FIG. 1A). The Rotor 12 is supported by the carrying walls of the Housing 11. The Blades are outfitted with extended half round Knobs on opposite sides, aligned with the top surface of the Blades (shown in FIG. 1A and FIG. 8). The Housing halves are joined with bolts, while at the interface a circular spring-loaded metallic face seal 17 and rubber compound seal 18 is clamped to ascertain a leak proof connection (shown in FIG. 1A). The Rotor which is supported by the interior carrying walls of the Housing, are provided with semi-metallic seals 20 and nylon carbon seals 19 and 21 to prevent gas leakage into the oil stream (shown in FIG. 1A). The Rotor is provided with a hollow core to transport oil for lubrication and cooling of rotating rods and the extended half round knobs of the blades guided in the hemispherical deep groove of the Housing. The torque diagram is shown in FIG. 1B, and is provided with accompanying analysis sheets.

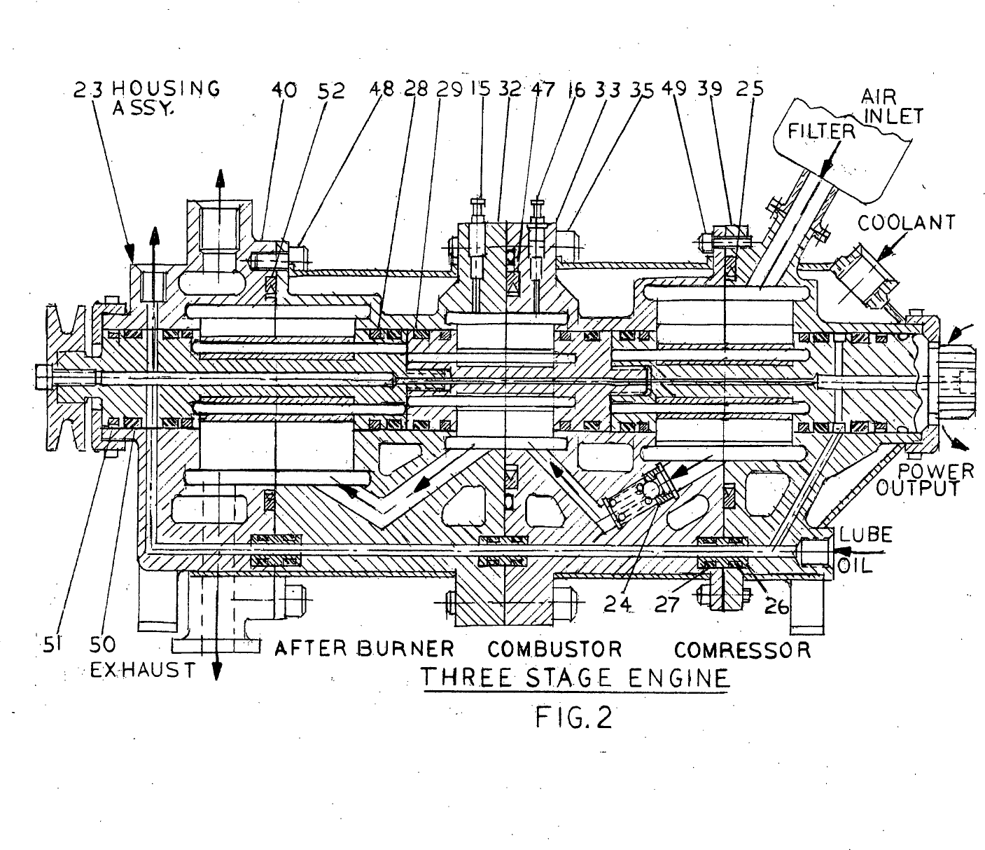

The Three-stage rotary internal combustion engine as exhibited in FIG. 2 comprises a Compressor unit, a Combustor unit and an Afterburner unit, combined and secured by means of bolts to form one assembled module. Several modules could be combined in series or in parallel configuration. In order to illustrate the invention clearly, external apparatus such as fuel injection and ignition system, water cooling radiator and pump, oil lubrication pump system, starting system and external piping are all omitted.

The primary objective of this invention is to illustrate the operation of the embodiment of this Three-stage rotary internal combustion blade type engine system.

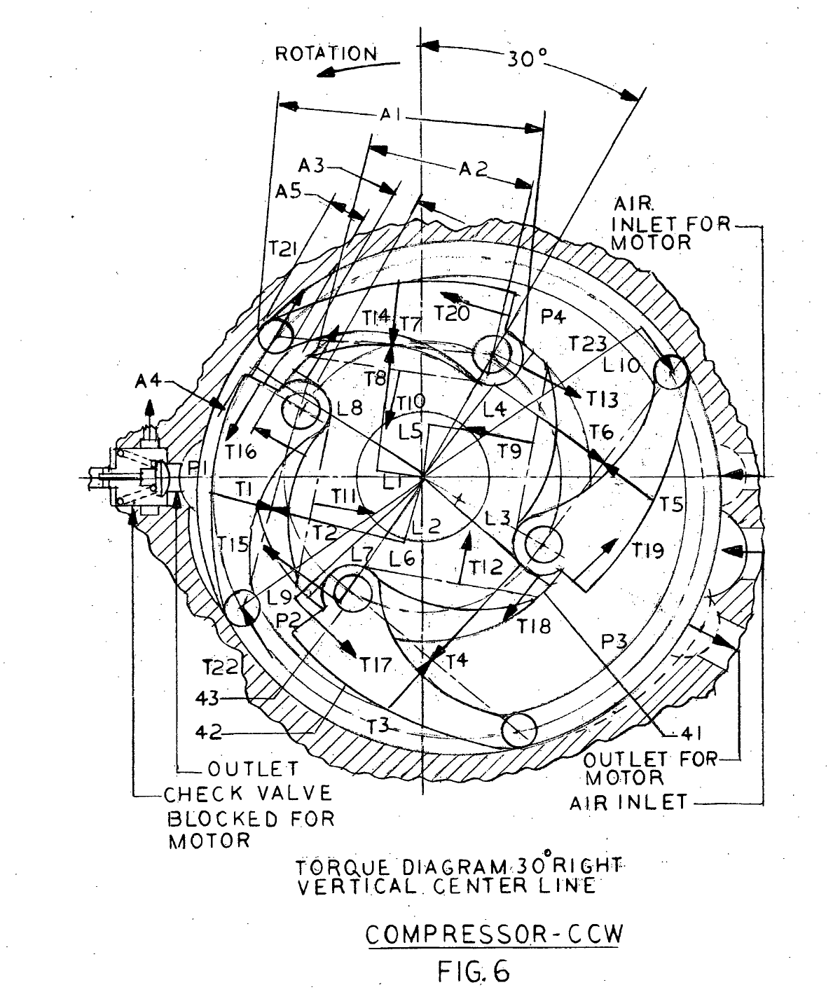

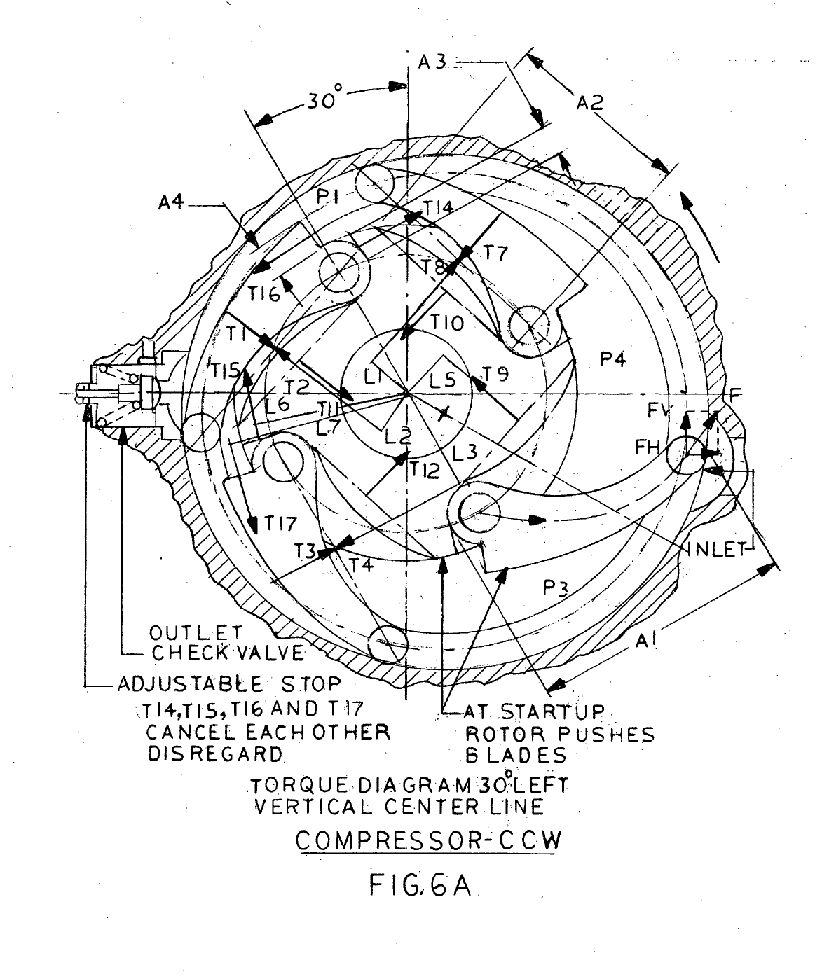

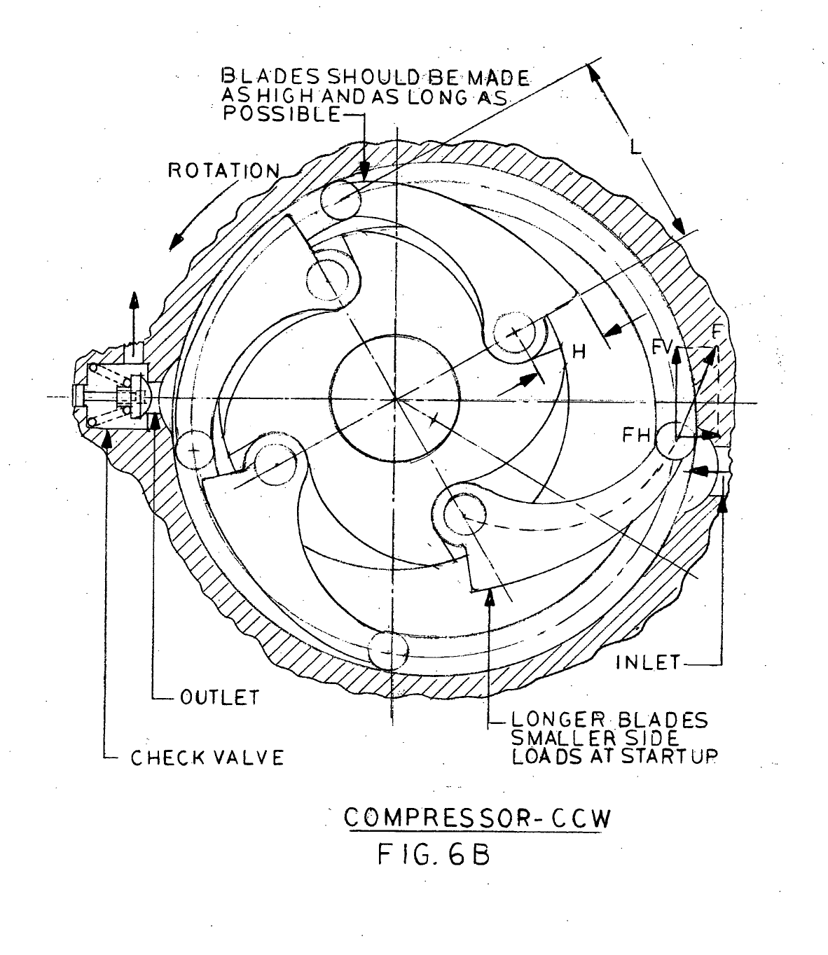

With reference to FIG. 2, FIG. 6, FIG. 6A and FIG. 6B: the Compressor comprises a cylindrical Rotor 41 (shown in FIG. 6) with a hollow core with splines on one end and mounted in an eccentric position within the Housing's interior and supported by the carrying walls of the Housing 33 and 39 (shown in FIG. 2). The Rotor 41 (shown in FIG. 6) is constructed with four cut-outs, ninety degrees apart, and four drilled holes (shown in FIG. 9) in which four curved Blades 42 are closely inserted and connected to the Rotor 41 by means of round free rotating rods 43 (shown in FIG. 6).

The Blades 42 (shown in FIG. 6) are outfitted with extended half round Knobs on opposite sides aligned with the top surface of the Blade (shown in FIG. 6 and FIG. 8). The Blades' extended Knobs are engaged in the deep hemispherical grooves of the interior side-walls of the Housing 39 and 33 (shown in FIG. 2).

The Housing halves 39 and 33 are secured by bolts 49 while at the interface a circular spring-loaded metallic face seal 25 (shown in FIG. 2) is clamped to ascertain a leak proof and structurally sound connection.

The Compressor's cylindrical Rotor comprises hollow core shaft with splines on one end (shown in FIG. 2), which is mounted in an eccentric position within the interior of the Housing and supported by the interior carrying walls of the Housing, and are provided with metallic gas seal and rubber carbon compound oil seal 28 and 29 (shown in FIG. 2) to prevent gas leakage into the oil stream. A combination of “O” rings and Teflon cap seals 50 and 51 (shown in FIG. 2) prevents external oil leakage.

The Rotor's hollow core transports oil for lubrication and cooling. The Housings are provided with a water coolant jacket; the fluid flow direction is from the Compressor towards the Afterburner (shown in FIG. 2). The Housing internal periphery walls (shown in FIG. 2, FIG. 6, FIG. 6A and FIG. 6B) are provided with an inlet port for air induction and compressed air expulsion through the outlet port for admission into the Combustor.

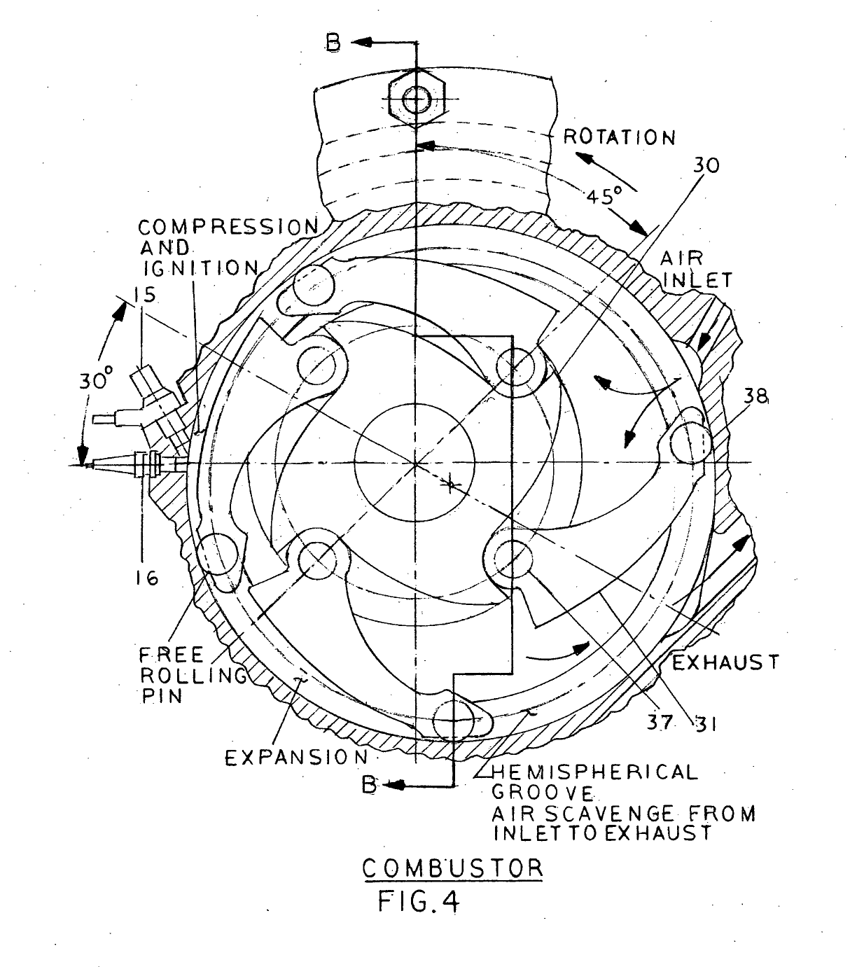

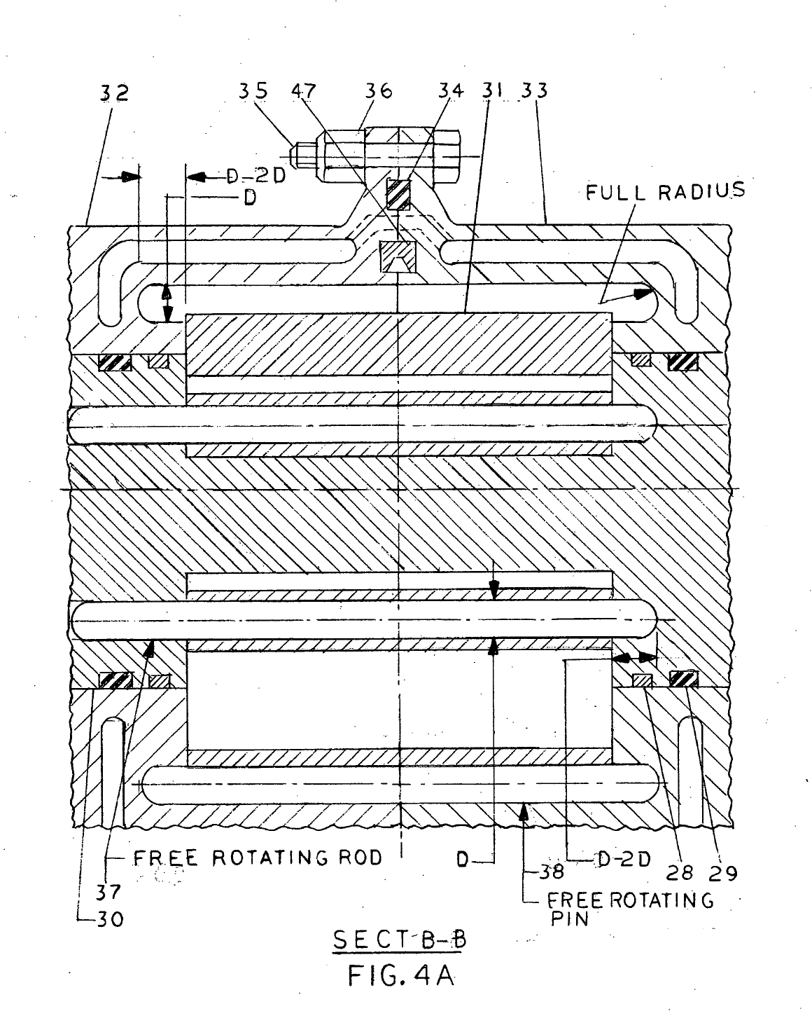

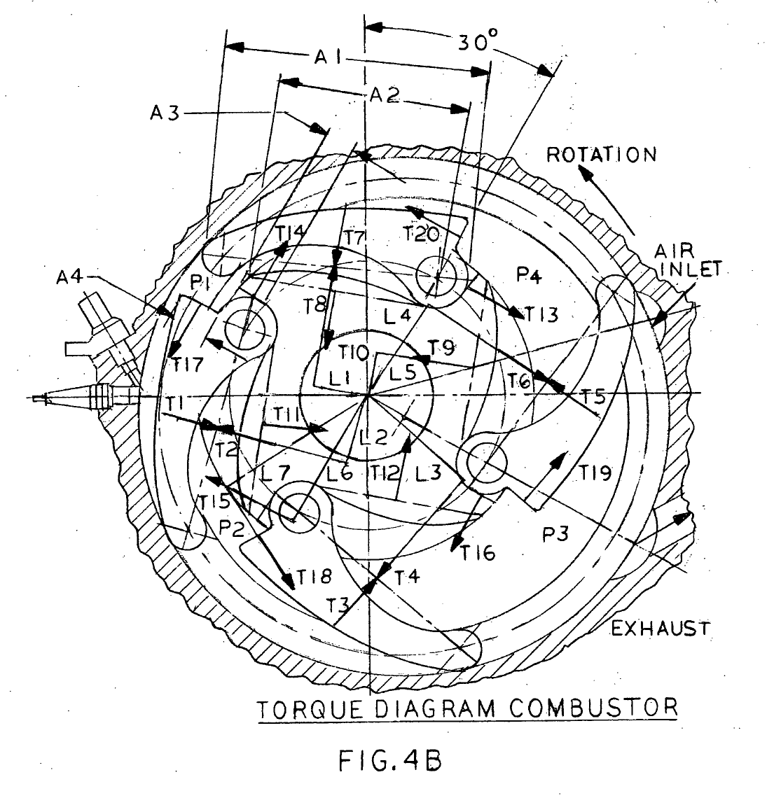

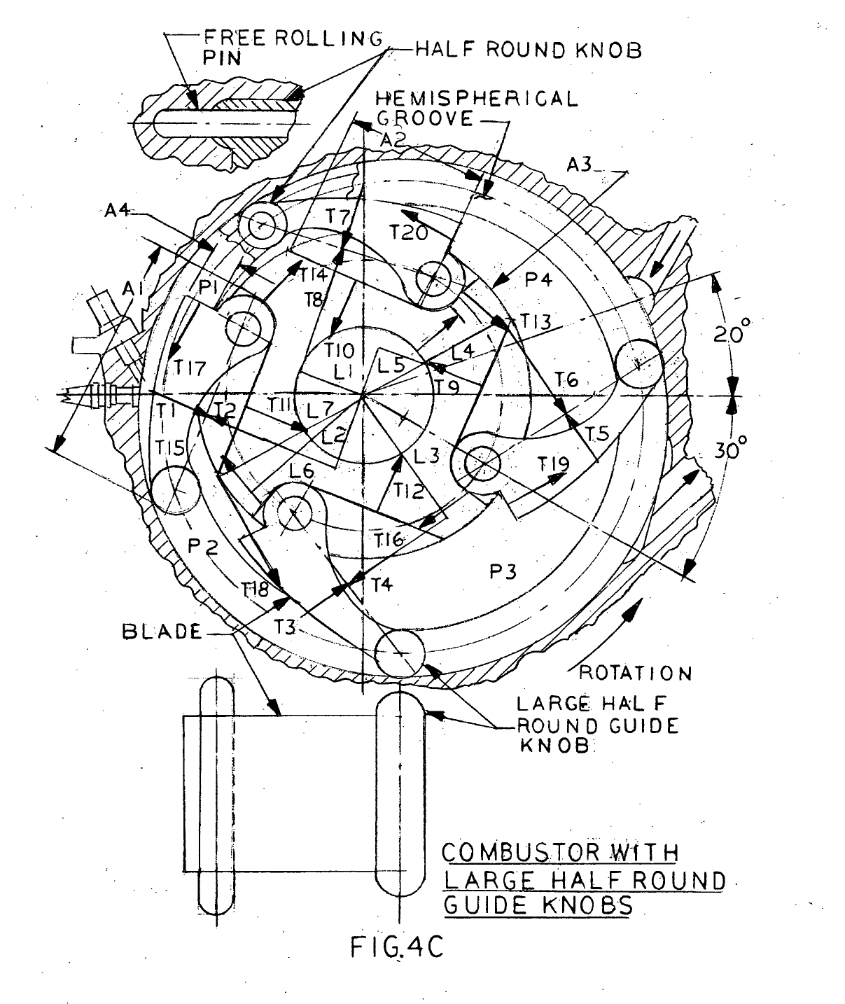

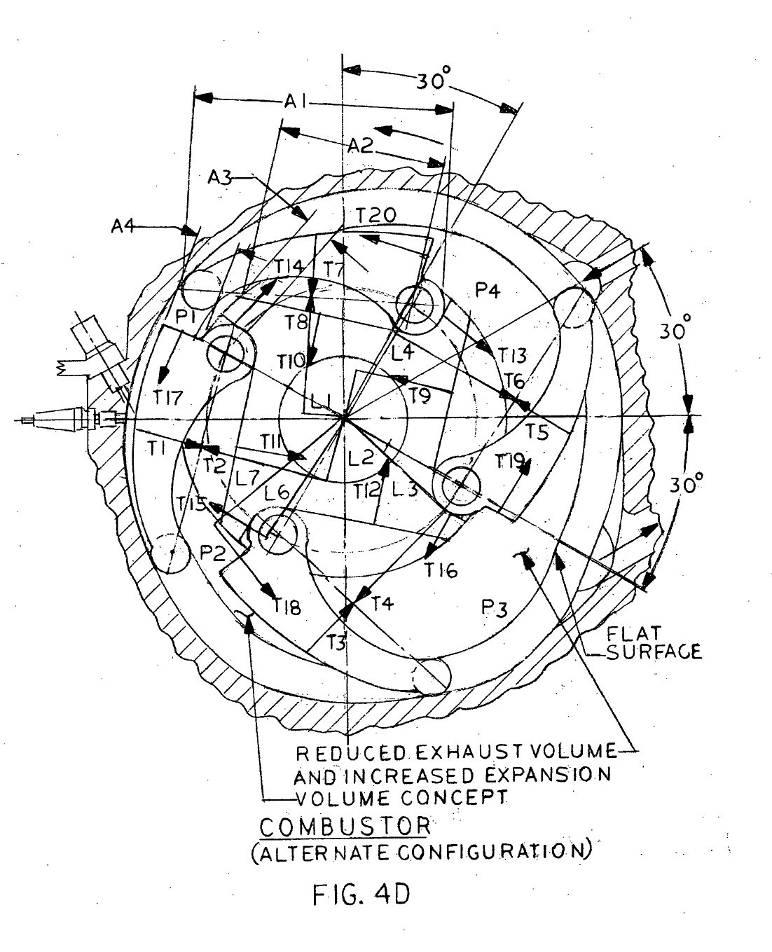

The Combustor shown in FIG. 2, FIG. 4, FIGS. 4A, 4B, 4C, and 4D comprises a cylindrical Rotor 30, (shown in FIG. 4 and FIG. 4A), mounted in an eccentric position within the interior of the Housing, and supported by the two interior carrying walls of the Housing halves 32 and 33 (shown in FIG. 2). The cylindrical Rotor with a hollow core and splines on both ends is constructed with four cut-outs and drilled holes, ninety degrees apart (shown in FIG. 9). In the cut-outs are closely inserted curved Blades 31 attached by means of rods 37, (shown in FIG. 4 and FIG. 4A). The curved Blades are provided with extended half round knobs at opposite sides, aligned with the top surface of the Blade (shown in FIG. 8) and are captured and guided in the deep hemispherical grooves in the interior side-walls of the Housing halves 32 and 33. (Shown in FIG. 2)

Semi-metallic and rubber carbon compound cap seals 28 and 29 are provided on both sides of the Rotor (shown in FIG. 2, and FIG. 4A) to prevent hot gas leakage into the oil cavity.

The Housing halves 32 and 33 (shown in FIG. 1 and FIG. 4A) are also provided with a water cooling jacket, while the Housing halves are secured by Bolts 35 (shown in FIG. 2) and optional lock-nuts 36 (shown in FIG. 4A), to provide a strong and rigid connection. At the Housing's interface, a circular spring loaded metallic seal 47, (shown in FIG. 2 and FIG. 4A) is installed and clamped to prevent hot gas leakage. Additionally, a rubber carbon seal 34 could be included as a back-up seal. (Shown in FIG. 4A)

On the interior housing wall periphery, glow-plugs or spark-plugs 16 and fuel injectors 15 are installed (shown in FIG. 2, FIG. 4, FIG. 4B, 4C, and FIG. 4D). The interior peripheral walls of the Housing 32 and 33 are provided with a gas outlet port to expel the exhaust gas and an inlet port to introduce fresh pre-compressed air from the Compressor for scavenge, combustion and work (shown in FIG. 2, FIG. 4, FIG. 4B, 4C, and FIG. 4D). Although a circular bore for the Housing internal periphery is the preferred design, a specially contoured configuration as shown in FIG. 4D is also feasible to facilitate movement of combustion gases to the exhaust port. FIG. 4C shows a Combustor configuration provided with large half round knobs.

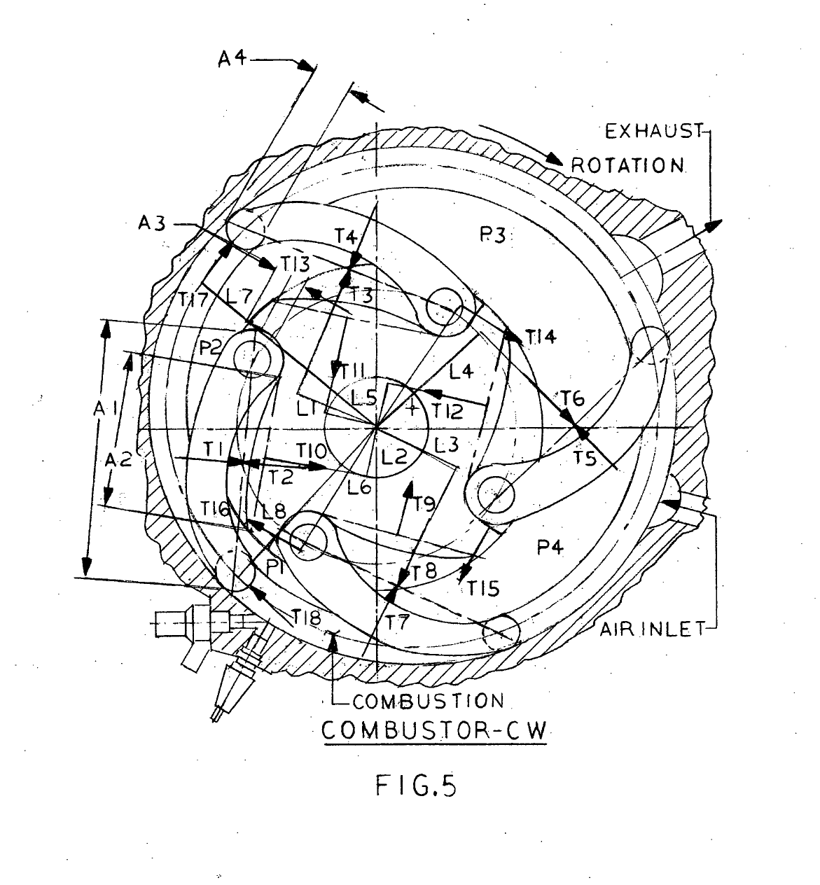

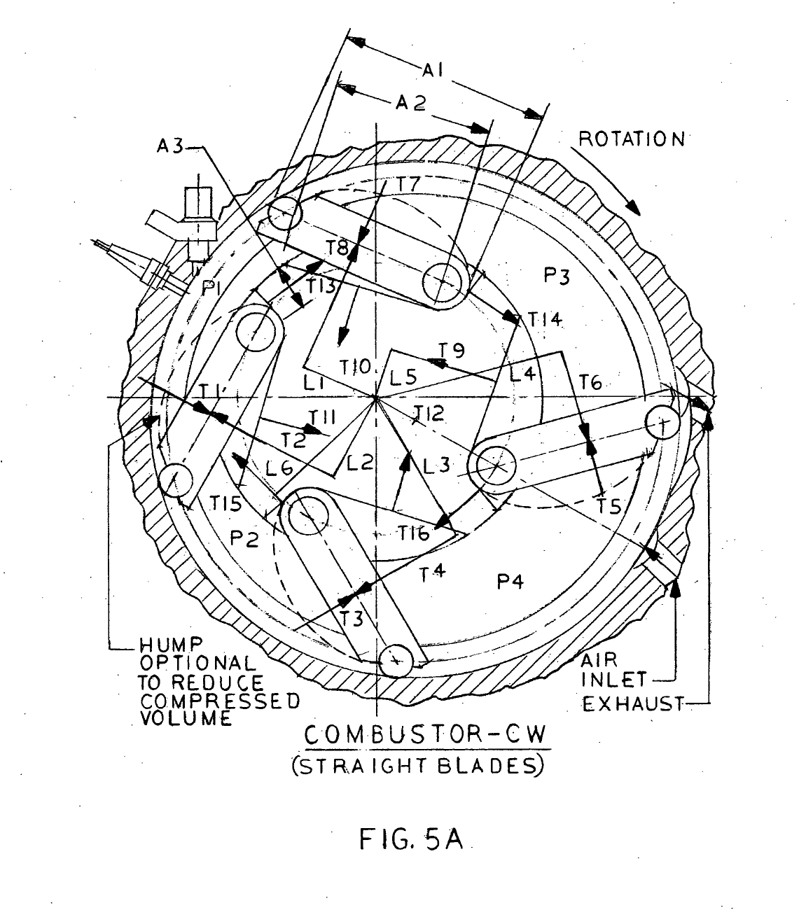

A Combustor clockwise rotation concept is shown in FIG. 5 with curved blades and in FIG. 5A with straight Blades. However, these clockwise rotation features are not as efficient as the counter clockwise configurations. This includes also the Compressor and the Afterburner.

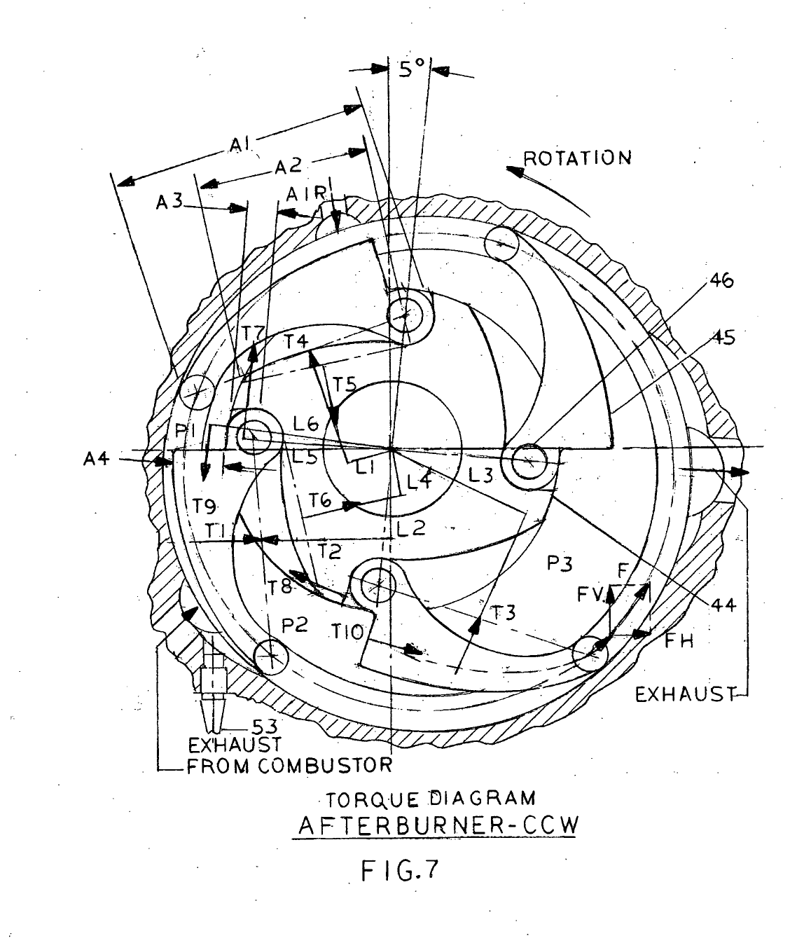

FIG. 2 and FIG. 7 show the Afterburner unit. It comprises a cylindrical Rotor 44 with a hollow core and splines on one end and is constructed with four cut-outs, ninety degrees apart, and four drilled holes (shown in FIG. 9), in which are closely inserted four curved Blades 45, which are connected to the Rotor 44 by means of four free rotating rods 46 (shown in FIG. 7). The curved Blades are provided with extended half round knobs at opposite sides (shown in FIG. 8) and are guided and captured in deep hemispherical grooves in the interior side-walls of the Housing halves 32 and 40 (shown n FIG. 2).

The cylindrical Rotor 44 is mounted in an eccentric position within the interior of the Housing halves 32 and 40 and are provided with semi metallic seals 28, carbon rubber seals 29 on both ends, and carbon rubber and Teflon cap seal 50 and 51 to prevent hot gas leakage into the oil cavities and to prevent external oil leakage. (Shown in FIG. 2).

Both Housing halves 32 and 40 (shown in FIG. 2) are provided with a water cooling jacket. At the interface joint a circular spring-loaded metallic seal 52 is installed. The Housing halves 32 and 40 are secured by means of bolts 48 to provide a sturdy connection.

The interior wall periphery include an inlet and exhaust port (shown in FIG. 2 and FIG. 7), to admit the partly cooled by scavenge air, combustion gases from the combustor, and to expel the lean re-burned gases to the atmosphere. A glow plug 53 is incorporated. (Shown in FIG. 7).

FIG. 1B shows a Torque diagram of a Single stage engine. The objective is to present a method to analyze torque value at a certain position of the Blades as shown in the accompanying analysis sheet. For every Blade position the torque value fluctuates, but the analysis shows the results of a positive torque.

FIG. 6 and FIG. 6A show the torque diagram of the Compressor with the Blades at two different positions, at thirty degrees before the vertical centerline and thirty degrees after the vertical centerline in a counter clockwise rotation. The accompanying analysis sheets show the torque results at the two positions, and as can be seen it fluctuates, but torques are always positive. The results of the analysis shows that with the outlet port capped, the compressor could function as a self generating torque providing air motor, once the Rotor rotates

FIG. 4B and FIG. 4C show the torque diagram of the Combustor. The accompanying analysis sheet shows the torque value with the Blade at thirty degrees before the vertical centerline in a counter clockwise rotation.

FIG. 5 and FIG. 5A Show the torque diagram of the Combustor in a clockwise rotation. (FIG. 5 shows a configuration with curved Blades and FIG. 5A shows a configuration with straight Blades.) The accompanying analysis sheets show the result of the torque values for both configurations. It is not as effective as the counter clockwise configuration.

FIG. 7 Shows the Afterburner with a torque diagram. The accompanying analysis sheets show the results of additional torque generated by the exhaust gases from the Combustor.

FIG. 8 shows the various Blade configurations with the extended half-round knobs.

FIG. 9 shows the Rotor of the Combustor which is identical for all units. With the exception of the Compressor and the Afterburner which have splines on only one end (a female for the Compressor and a male for the Afterburner. (Shown in FIG. 2).

The final analysis sheet shows the total torque developed by the Three-stage rotary internal combustion engine, is the sum of the torques developed by the Combustor, Afterburner and also the Compressor. Since the torque values fluctuate based on the Blade position, an average value of 50% of the total torque results in a tremendous torque and power output, based on four power cycles per revolution. The exact horsepower is based on the speed of rotation and overall efficiency.

### DRAWINGS REFERENCE NUMERALS

### Single-Stage Engine

### FIGS. 1, 1A and 1B

| Item Nr. | | |
|---|---|---|
| 11 | Housing Assembly | Inconel alloy 718 |
| 12 | Rotor | Inconel alloy 625 |
| 13 | Blade | Inconel alloy 625, coated |
| | | zirconium carbide |
| 14 | Rod | Inconel alloy 625, coated |
| | | zirconium carbide |
| 15 | Fuel Injector | Standard part |
| 16 | Glow Plug/Spark Plug | Standard part |
| 17 | Metal Gas Spring Seal | Inconel alloy 718 |
| 18 | Coolant Seal | PTFE + 25% graphite |
| 19 | Rubber Carbon Compound Seal | PTFE + 25% carbon/ |
| | | graphite |
| 20 | Metal Gas Seal | Inconel alloy 718 |
| 21 | Rubber Carbon Oil Seal | PTFE + 25% carbon/ |
| | | graphite |
| 22 | Bolt | Inconel alloy 718 |

### DRAWINGS REFERENCE NUMERALS

### Three-Stage Engine

### Assembly

### FIG. 2

| Item Nr. | | |
|---|---|---|
| 15 | Fuel Injector | Standard part |
| 16 | Glow plug | Standard part |
| 23 | Housing Assembly - Three stage engine | Inconel alloy 718 |
| 24 | Check Valve | Standard part |
| 25 | Spring Loaded Metallic Seal - | Inconel alloy 718 |
| | Compressor | |
| 26 | Transfer Tube - 3 places | 304 Cres |
| 27 | Oil Seal - places | Modified PTFE |
| 28 | Metallic Gas Seal - 6 places | Inconel alloy 718 |
| 29 | Rubber Carbon Compound Oil Seal 6 | PTFE + 25% |
| | places | carbon |
| 32 | Housing half - Combustor and | Inconel alloy 718 |
| | Afterburner | |
| 33 | Housing half - Combustor and | Inconel alloy 718 |
| | Compressor | |
| 35 | Bolt - Combustor | Inconel alloy 718 |
| 39 | Housing half - Compressor | Inconel alloy 718 |
| 40 | Housing half - Afterburner | Inconel alloy 718 |
| 47 | High pressure spring loaded metallic | Inconel alloy 718 |
| | seal - Combustor | |
| 48 | Bolt - Afterburner | Inconel alloy 718 |

### DRAWINGS REFERENCE NUMERALS

### Three-Stage Engine

### Assembly

### FIG. 2

| Item Nr. | | |
|---|---|---|
| 49 | Bolt - Compressor | Inconel alloy 718 |
| 50 | Rubber carbon compound | PTFE + 25% carbon/graphite |
| | seal - 2 places | |
| 51 | Cap seal - 2 places | PTFE + 60% bronze |
| 52 | Spring loaded metallic | Inconel alloy 718 |
| | seal - Afterburner | |

### Engine Schematic

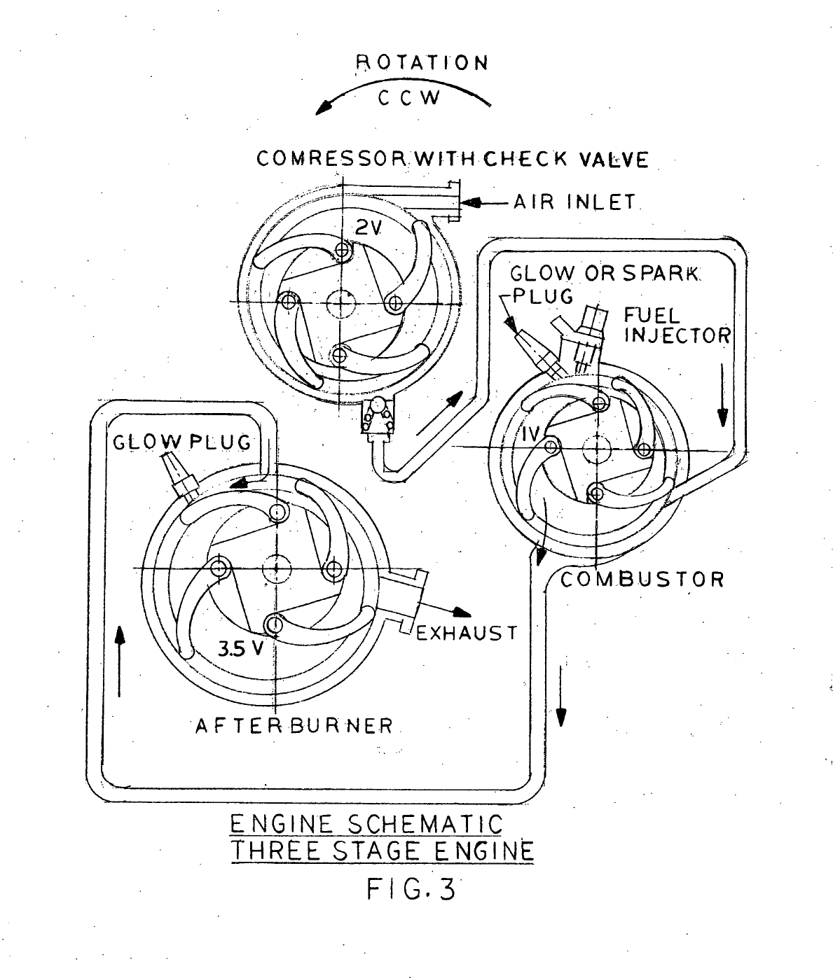

### FIG. 3

The Engine schematic depicts Compressor, Combustor and Afterburner integration including air and gas flow path.

### Combustor

### FIG. 4, FIGS. 4A, 4B, 4C and 4D

| Item Nr. | | |
|---|---|---|
| 30 | Rotor | Inconel alloy 625 |
| 31 | Blade - 4 places | Inconel alloy 625 - zirconium carbide |
| 33 | Pin - 4 places | Inconel alloy 625 - zirconium carbide |
| 34 | Rubber Carbon | PTFE + 15% graphite |
| | Compound Seal | |
| 35 | Bolt | Inconel alloy 718 |
| 36 | Locknut | Inconel alloy 718 |
| 37 | Rod | Inconel alloy 625 - zirconium carbide |

### DRAWINGS REFERENCE NUMERALS

### Three-Stage Engine

### Combustor

### FIGS. 5 and 5A

Combustor with curved and straight blades—clockwise rotation.

### Compressor

### FIGS. 6, 6A and 6B

| Item Nr. | | |
|---|---|---|
| 41 | Rotor | Inconel alloy 625 |
| 42 | Blade - 4 places | Inconel alloy 625 zirconium carbide |
| 43 | Rod | Inconel alloy 625 zirconium carbide |

### Afterburner

### FIG. 7

| Item Nr. | | |
|---|---|---|
| 44 | Rotor | Inconel alloy 625 |
| 45 | Blade - 4 places | Inconel alloy 625 zirconium carbide |
| 46 | Rod | Inconel alloy 625 zirconium carbide |
| 53 | Glow plug | Standard part |

### Blade Configurations

### FIG. 8

Concepts of various Blade configurations and designs.

### DRAWINGS REFERENCE NUMERALS

### Three-Stage Engine

### Rotor

### FIG. 9

Typical Rotor for Compressor, Combustor and Afterburner.

### Analysis

An analysis of the Single-stage and the Three-stage rotary internal combustion engine of the blade type are included. The purpose is to present the derivations of the torque values generated by the rotating and sliding blades, guided by the internal periphery housing grooves on one end and attached to the rotor at the other end.

The analysis is shown for the blades in a fixed position, since during rotation of the rotor, the blades' geometry and torque arm length changes.

The results of the torque values obtained indicate that for a counter clockwise rotation of the rotor and blades, a consistent positive torque is generated.

Although the generated torque values fluctuate during rotation, a worst case scenario of the average torques has been assumed to be approximately fifty percent, for both the Single-stage and the Three-stage engine.

The total delivered torques of the three stage engine is the sum of the Compressor, Combustor, and Afterburner torques, which, based on the analysis, is efficient and substantial.

### Single-Stage Engine CCW

### FIG. 1B

A1 Projected Blade Area
A2 Cutout of Rotor Projected Area
A3 Blade to Rotor Cutout Area
A4 Back Side Blade Area
P1 Compressed air and Initial Combustion
P2 Expanded Combustion Gases
P3 Exhaust Gases
P4 Inlet Suction Air
L1, L2, L3, L4, L5, L6, and L7 Torque Arm Length
L3, L4, and L5 Fixed Length

T1 = P1 * A1 * L2
T2 = P2 * A1 * L2
T3 = P1 * A3 * L4
T4 = P4 * A1 * L6
T5 = P4 * A1 * L1
T6 = P1 * A1 * L1
T7 = P1 * A2 * L3
T8 = P1 * A4 * L5
T9 = P2 * A1 * L7
T10 = P2 * A4 * L5
T11 = P2 * A2 * L3
T12 = P2 * A3 * L4
T13 = P4 * A4 * L5
T14 = P4 * A3 * L4
T15 = P3 * A4 * L5
T16 = P3 * A3 * L4
T17 = P3 * A1 * L7
T18 = P3 * A1 * L6
T19 = P4 * A2 * L3
T20 = P3 * A2 * L3
Notes.
P3 and P4 are low pressures.

Disregard the following:

T4, T5, T13, T14, T15, T16, T17, T19 and T20.

T3, T8, T10, and T12 cancel each other out

Torque developed:

$$\begin{matrix}T 1 - T 2 - T 6 + T 7 + T 11 + T 9 \\ \begin{matrix}T = P 1 * A 1 * L 2 - P 2 * A 1 * L 2 - P 1 * A 1 * L 1 + \\ P 1 * A 2 * L 3 + P 2 * A 2 * L 3 + P 2 * A 1 * L 7 \\ = P 1 * A 1 ( L 2 - L 1 ) + P 2 * A 1 ( L 7 - L 2 ) + \\ P 1 * A 2 * L 3 + P 2 * A 2 * L 3 \\ = P 1 * A 1 ( L 2 - L 1 ) + P 2 * A 1 ( L 7 - L 2 ) + A 2 * L 3 ( P 1 + P 2 )\end{matrix} & ( 19 ) \\ A 2 = 0.77 * A 1 \\ L 2 = 2.75 ** L 1 \\ L 3 = 1.125 * L 1 \\ L 7 = 1.1 * L 1 & \end{matrix}$$

Substituting above values in (19)

Torque developed at the shown blades position at initial combustion:

$$= P 1 * A 1 ( 2.75 * L 1 - L 1 ) + P 2 * A 1 ( 1.1 * L 1 - 2.75 * L 1 ) + ( 0.77 * A 1 ) ( 1.125 * L 1 ) ( P 1 + P 2 ) \\ = 1.75 * P 1 * A 1 * L 1 - 1.65 * P 2 * A 1 * L 1 + 0.866 * A 1 * L 1 ( P 1 + P 2 ) \\ = 2.616 * P 1 * A 1 * L 1 - 0.784 * P 2 * A 1 * L 1 \\ = A 1 * L 1 ( 2.62 P 1 - 0.78 P 2 ) \qquad ( 20 )$$

The final output and power will be the average of the maximum and minimum torque values.

Assume that in the worst case scenario, the average torque is:

A1*L1(2.6P1−0.8P2)*05 (20A)

HP=A1*L1(2.6P1−0.8P2)*0.5*N/5252*4*EFF (20B)

N=RPM (Revolutions per Minute)

4 cycles per revolution

EFF=Total efficiency

### Three-Stage Engine

### Compressor—CCW

### FIG. 6

At 30 degrees right from vertical center line,
A1 Projected blade area
A2 Projected rotor cut-out area
A3 Blade to rotor cutout area
A4 Back side blade area

Areas are based on similar width of all components.
P1 Maximum compressed air pressure
P2 Expanded residual air pressure
P3 Inlet air pressure
P4 Initial Compressed air pressure
L1, L2, L3, L4, L5, L6, L7, L8, L9, and L10—Torque arm length
L5, L6, and L7—Constant

Torque Values

T1 = P1 * A1 * L2
T2 = P2 * A1 * L2
T3 = P2 * A1 * L3
T4 = P3 * A1 * L3
T5 = P3 * A1 * L4
T6 = P4 * A1 * L4
T7 = P4 * A1 * L1
T8 = P1 * A1 * L1
T9 = P4 * A2 * L5
T10 = P1 * A2 * L5
T11 = P2 * A2 * L5
T12 = P3 * A2 * L5
T13 = P4 * A3 * L6
T14 = P1 * A3 * L6
T15 = P2 * A3 * L6
T16 = P1 * A4 * L7
T17 = P2 * A4 * L7
T18 = P3 * A3 * L6
T19 = P3 * A4 * L7
T20 = P4 * A4 * L7
T21 = P1 * A5 * L8
T22 = P2 * A5 * L9
T23 = P4 * A5 * L10

T13, T14, T15, T16, T17, T18, T19, and T20 are small, cancel each other out and will be disregarded for simplification.

P3 is atmospheric pressure and P2 is expanded exhaust pressure.

Therefore, T4, T5, T12, T2, T3, and T11 can be disregarded.

The torque required or developed is:

$$T 1 - T 8 + T 7 + T 10 - T 6 + T 9 = P 1 * A 1 * L 2 - P 1 * A 1 * L 1 + P 4 * A 1 * L 1 + P 1 * A 2 * L 5 - P 4 * A 1 * L 4 + P 4 * A 2 * L 5 = P 1 [ A 1 * L 2 - A 1 * L 1 + A 2 * L 5 ] + P 4 [ A 1 * L 1 + A 2 * L 5 - A 1 * L 4 ] \qquad ( 1 )$$

From FIG. 6

| | |
|---|---|
| L2 = 1.625 * L1 | L5 = 1.25 * L1 |
| L4 = 2.75 * L1 | A2 = 0.64 * A1 |

Substituting the above values into (1) torque required or developed:=

=P1[1.625*L1*A1−A1*L1+(1.25)(0.64)L1*A1]+P4[A1*L1+A2*L5−A1*L4] (2)

P1[1.425*A1*L1]+P4[A1*L1+0.64*A1(1.25*L1)−2.75*A1*L1] (3)

P1[1.425*A1*L1]−P4*A1*L1*0.95 (4)

P1 is much greater than P4

Torque developed is:

T=1.425*P1*A1*L1−P4*A1*L1

T=A1*/l1(1.425P1−P4) (5)

Since P1 is much greater than P4 the torque is positive.

Notes.

P3 is atmospheric inlet pressure.

P2 is expansion pressure.

Alternative condition with check valve blocked and outlet port closed.

Disregard T4, T5 and T12.

Torque required or developed:

T1−T2+T11+T3−T8+T7+T10−T6+T9=P1*A1*L2−P2*A1*L2+P2*A2*L5+P2*A1*L3−P1*A1*L1+P4*A1*L1+P1*A2*L5−P4*A1*L4+P4*A2*L5=A1[P1(L2−L1)+P2(L3−L2)+P4(L1−L4)]+A2(P1*L5+P2*L5+P4*L5) (6)

Alternatively simplified,

P1[A1*L2−A1*L1+A2*L5]=TA

P2[A1*L3+A2*L5−A1*L2]=TB

P4[A1*L1−A1*L4+A2*L5]=TC

From FIG. 6

| | | |
|---|---|---|
| L2 = 1.625 * L1 | L3 = 3 * L1 | L4 = 2.75 * L1 |
| L5 = 1.25 * L1 | | A2 = 0.64 * A1 |

Substituting these values into (6) torque is, TA+TB+TC

P1[1.625*L1*A1−L1*A1+(1.25)(0.64)L1*A1]=1.425*A1*L1*P1

P2[3*L1*A1+(1.25)(0.64)L1*A1−1.625*L1*A1]=2.175*A1*L1*P2

P4[A1*L1−2.75L1*A1+(1.25)(0.64)L1*A1]=−0.95*A1*L1*P4

Total torque is: TA+TB+TC (From 6)

P1[A1*L2−A1*L1+A2*L5]+P2[A1*L3+A2*L5−A1*L2]+P4[A1*L1−A1*L4+A2*L5]

(1.425*L1*A1*P1+2.175L1*A1*P2−0.95*L1*A1*P4) (7)

For P4=P2 (Conservatively)

Torque developed is positive, based on the shortest torque arm length L1, Fixed blade area A1, Compressed pressure P1 and expanded pressure P2.

1.425*L1*A1*P1+1.225*L1*A1*P2

T=L1*A1(1.425P1+1.225P2) (8)

The difference between an open or plugged exhaust and a blocked check valve is the torque developed by the P2 pressure.

From the above analysis the results show that a positive or available torque is possible. Therefore, a compressor with the exhaust plugged could possibly function as a self generating rotating air motor; once the rotor is rotating, the compressed pressure P1 is high, P2 is higher than P4, and mechanical friction is low.

From FIG. 6A

At 30 degrees left from vertical centerline:

| | |
|---|---|
| T1 = P1 * A1 * L2 | T3 = P2 * A1 * L3 |
| T2 = P2 * A1 * L2 | |
| T8 = P1 * A1 * L1 | T11 = P2 * A2 * L5 |
| T10 = P1 * A2 * L5 | |
| L2 = L1 | L3 = 2.22 * L1 |
| L5 = 1.1 * L1 | A2 = 0.64 * A1 |

Total torque is:

T1−T2+T11+T3−T8+T10

P1*A1*L2−P2*A1*L2+P2*A2*L5+P2*A1*L3−P1*A1*L1+P1*A2*L5=P1[A1*L2−A1*L1+A2*L5]+P2[A1*L3+A2*L5−A1*L2] (9)

Substituting the above values into (9)

T=P1[A1*L1−A1*L1+0.7A1*L1]+P2[2.22A1*L1+0.7A1*L1−A1*L1] (10)

=P1(0.7A1*L1)+P2(1.9A1*L1)

Torque developed is positive 60 degrees rotated

T=0.7*L1*A1*P1+1.9*L1*A1*P2 (11)

Which is less than the previous result, but rotating another 30 degrees the result will be similar to the previous blade position.

Worst case scenario:—Compressor (FIG. 6) with blocked check valve and opposing pressures against blade guided ends creating torques T21, T22 and T23.

| | |
|---|---|
| A5 = 0.14 * A1 | L9 = 4.78 * L1 |
| L8 = 4.2 * L1 | L10 = 5.54 * L1 |

T21=P1*0.14*A1*4.2*L1=0.588*P1*A1*L1

T22=P2*0.14*A1*4.78*L1=0.67*P2*A1*L1

T23=P4*0.14*A1*5.54*L1=0.78*P4*A1*L1

Torque developed is subtracting T21, T22 and T23

(1.425*L1*A1*P1+1.225*L1*A1*P2)−(0.588*L1*A1*P1+0.67*L1*A1*P2+0.78*L1*A1*P4) (12)

For simplification substituting P2−P4

T=0.837*L1*A1*P1−0.225*L1*A1*P2 (12a)

Which is still positive or

$$P 1 = ( \frac{0.225}{0.837} ) * P 2 > 0.27 * P 2$$

As long as P1 is greater than 0.27·P2 there will be always a positive aiding torque. Based on the value of (11)

T=0.7*L1*A1*P1+1.9*L1*A1*P2

And subtracting T21, T22, T23—the very worst case scenario—substituting P2=P4

(0.7*L1*A1*P1+1.9*L1*A1*P2)−(0.588*L1*A1*P1+0.67*L1*A1*P2+0.78*L1*A1*P4)

T=0.112*L1*A1*P1+0.45*L1*A1*P2

T=L1*A1(0.112P1+0.45P2) (13)

A positive torque is generated in the worst case scenario.

### Three-Stage Engine

### Combustor CCW

### FIG. 4B

At 30 degrees right from vertical centerline:
A1 Projected blade area
A2 Projected cutout rotor area
A3 Blade to rotor cutout area
A4 Backside blade area
P1 Maximum compressed air and initial combustion
P2 Expanded combustion gases
P3 Exhaust gases and inlet air for scavenging
P4 Compressed inlet air
L1, L2, L3, L4, L5, L6, and L7 are variable torque arm length

L5, L6, and L7 are fixed arm length

At the position of the blades shown the torque values are:

T1 = P1 * A1 * L2
T2 = P2 * A1 * L2
T3 = P2 * A1 * L3
T4 = P3 * A1 * L3
T5 = P3 * A1 * L4
T6 = P4 * A1 * L4
T7 = P4 * A1 * L1
T8 = P1 * A1 * L1
T9 = P4 * A2 * L5
T10 = P1 * A2 * L5
T11 = P2 * A2 * L5
T12 = P3 * A2 * L5
T13 = P4 * A3 * L6
T14 = P1 * A3 * L6
T15 = P2 * A3 * L6
T16 = P3 * A3 * L6
T17 = P1 * A4 * L7
T18 = P2 * A4 * L7
T19 = P3 * A4 * L7
T20 = P4 * A4 * L7

T13, T14, T15, and T16 are smaller than T17, T18, T19, and T20 and are considered to cancel each other out.

T5, T4, and T12 are low torque due to low pressure.

At the position shown, the total torque developed is

T1−T2+T3−T6+T7−T8+T9+T10+T11=P1*A1*L2−P2*A1*L2+P2*A1*L3−P4*A1*L4+P4*A1*L1−P1*A1*L1+P4*A2*L5+P1*A2*L5+P2*A2*L5=T=P1*A1(L2−L1)+P2*A1(L3−L2)+P4*A1(L1−L4)+A2*L5(P4+P1+P2) (12)

From FIG. 4B

| | | | |
|---|---|---|---|
| L2 = 1.75 * L1 | L3 = 3.0 * L1 | L4 = 2.75 * L1 | L5 = L1 |
| A2 = 0.68 * A1 | | | |

Substituting these values into (12)

$$\begin{matrix}T = P 1 * A 1 ( 0.75 * L 1 ) + P 2 * A 1 ( 1.25 * L 1 ) - P 4 * A 1 ( 1.75 * L 1 ) + 0.68 * A 1 * L 1 ( P 4 + P 1 + P 2 ) & ( 13 ) \\ Or . & \\ T = A 1 * L 1 [ 0.75 * P 1 + 1.25 * P 2 - 1.75 * P 4 ] + [ 0.68 * A 1 * L 1 ( P 4 + P 1 + P 2 ) ] \\ = A 1 * L 1 ( 1.43 * P 1 + 1.93 * P 2 - 1.07 * P 4 ) & ( 14 )\end{matrix}$$

Based on shortest torque arm length L1, Fixed area A1, initial combustion pressure P1, expanded pressure P2 and pre-compressed air P4.

The higher P4, the higher the compressed air P1.

### Three-Stage Engine

### Combustor C.W.

### Curved Blades

### FIG. 5

A1 Projected blade area
A2 Cutout rotor projected area
A3 Blade to rotor cutout area
P1 Compressed air, ignition and combustion
P2 Expanded combustion gases
P3 Exhaust gases and inlet air for scavenging
P4 Inlet air from compressor
L1, L2, L3, L4, L5, and L6 Length of torque arms.
L5, and L6 Fixed length of torque arms.

Torques:

T1 = P2 * A1 * L2
T2 = P1 * A1 * L2
T3 = P2 * A1 * L1
T4 = P3 * A1 * L1
T5 = P4 * A1 * L4
T6 = P3 * A1 * L4
T7 = P1 * A1 * L3
T8 = P4 * A1 * L3
T9 = P4 * A2 * L5
T10 = P1 * A2 * L5
T11 = P2 * A2 * L5
T12 = P3 * A2 * L5
T13 = P2 * A3 * L6
T14 = P3 * A3 * L6
T15 = P4 * A3 * L6
T16 = P1 * A3 * L6
Notes,
P3 = Exhaust pressure.

The following torque values can be disregarded, T4, T14, T6, and T12.

The torque developed in the position shown.

$$= - T 7 + T 8 + T 15 + T 16 + T 2 - T 1 - T 10 + T 13 + T 3 - T 5 - T 11 - T 9 \\ = - P 1 * A 1 * L 3 + P 4 * A 1 + L 3 + P 4 + A 3 * L 6 + P 1 * A 3 * L 6 + P 1 * A 1 * L 2 - P 2 * A 1 * L 2 - P 1 * A 2 * L 5 + P 2 * A 3 * L 6 + P 2 * A 1 * L 1 - P 4 * A 1 * L 4 - P 2 * A 2 * L 5 - P 4 * A 2 * L 5 \\ = + P 1 * A 1 ( L 2 - L 3 ) + P 4 * A 1 ( L 3 - L 4 ) + P 2 * A 1 ( L 1 - L 2 ) + P 4 * A 3 * L 6 + P 1 ( A 3 * L 6 - A 2 * L 5 ) + P 2 * A 3 * L 6 - A 2 * L 5 ( P 2 + P 4 ) \qquad ( 15 )$$

FIG. 5

| | | | |
|---|---|---|---|
| L2 = 0.56 * L1 | L3 = 1.10 * L1 | L4 = 1.68 * L1 | L5 = 0.56 * L1 |
| L6 = 1.73 * L1 | | | |
| A2 = 0.6 * A1 | A3 = 0.12 * A1 | L1 = 0.8 | A1 = 2.5 |

Substituting above values into (15)

$$T = A 1 * P 1 ( 0.56 * L 1 - 1.10 * L 1 ) + A 1 * P 4 ( 1.10 * L 1 - 1.68 * L 1 ) + A 1 * P 2 ( L 1 - 0.56 * L 1 ) + P 4 [ 0.12 * A 1 ( 1.73 * L 1 ) ] + P 1 [ 0.12 * A 1 ( 1.73 * L 1 ) ] + P 2 [ 0.12 * A 1 ( 1.73 * L 1 ) ] - ( 0.6 * A 1 ) ( 0.56 * L 1 ) ( P 2 + P 4 ) \\ T = + A 1 * P 1 ( - 0.54 * L 1 ) + A 1 * P 4 ( - 0.58 * L 1 ) + A 1 * P 2 ( 0.44 * L 1 ) + A 1 * P 4 ( 0.208 * L 1 ) + A 1 * P 1 ( 0.208 * L 1 ) + A 1 * P 2 ( 0.208 * L 1 ) - 0.336 * A 1 * L 1 * P 2 - 0.336 * A 1 * L 1 * P 4 \\ T = - 0.54 * A 1 * P 1 * L 1 - 0.58 * A 1 * P 4 * L 1 + 0.44 * A 1 * P 2 * L 1 + 0.208 * A 1 * P 4 * L 1 + 0.208 * A 1 * P 1 * L 1 + 0.208 * A 1 * P 2 * L 1 - 0.336 * A 1 * L 1 * P 2 - 0.336 * A 1 * L 1 * P 4 \\ = - 0.332 * A 1 * P 1 * L 1 + 0.312 * A 1 * P 2 * L 1 - 0.708 * A 1 * P 4 * L 1 \\ T = A 1 * L 1 ( - 0.332 * P 1 + 0.311 * P 2 - 0.71 * P 4 ) \qquad ( 16 )$$

Note:

This configuration cannot provide torque and power.

### Three-Stage Engine

### Combustor CW

### Straight Blades

### FIG. 5A

A1 Projected blade area
A2 Cutout rotor projected area
A3 Blade to rotor cutout area
P1 Compressed air, ignition and combustion
P2 Compressed air
P3 Exhaust gases and inlet air for scavenging
P4 Inlet air
L1, L2, L3, L4, L5, and L6—Length of torque arms
L5 and L6—Fixed length of torque arms

Torques:

T1 = P1 * A1 * L2
T2 = P2 * A1 * L2
T3 = P2 * A1 * L3
T4 = P4 * A1 * L3
T5 = P4 * A1 * L4
T6 = P3 * A1 * L4
T7 = P3 * A1 * L1
T8 = P1 * A1 * L1
T9 = P3 * A2 * L5
T10 = P1 * A2 * L5
T11 = P2 * A2 * L5
T12 = P4 * A2 * L5
T13 = P1 * A3 * L6
T14 = P3 * A3 * L6
T15 = P2 * A3 * L6
T16 = P4 * A3 * L6
Notes,
P3 is exhaust pressure.

The following torque values can be disregarded T6, T7, T9, and T14.

Torque developed at position shown:

$$- T 1 + T 2 + T 13 + T 8 - T 10 + T 16 - T 12 + T 4 - T 3 + T 15 - T 11 - T 5 \\ = - P 1 * A 1 * L 2 + P 2 * A 1 * L 2 + P 1 * A 3 * L 6 + P 1 * A 1 * L 1 - P 1 * A 2 * L 5 + P 4 * A 3 * L 6 - P 4 * A 2 * L 5 + P 4 * A 1 * L 3 - P 2 * A 1 * L 3 + P 2 * A 3 * L 6 - P 2 * A 2 * L 5 - P 4 * A 1 * L 4 \\ = P 1 * A 1 ( L 1 - L 2 ) + P 2 * A 1 ( L 2 - L 3 ) + P 4 * A 1 ( L 3 - L 4 ) + A 3 * L 6 ( P 1 + P 2 ) - P 1 * A 2 * L 5 + P 4 * A 3 * L 6 - A 2 * L 5 ( P 4 + P 2 ) \qquad ( 17 )$$

From FIG. 5A

L2=1.286*L1L3=2.286*L1L4=2.57*L1L5=0.7*L1L6=1.93*L1A2=0.73*A1A3=0.195*A1

Substituting the values into (17)

$$T = P 1 * A 1 ( L 1 - 1.286 * L 1 ) + P 2 * A 1 ( 1.286 * L 1 - 2.286 * L 1 ) + P 4 * A 1 ( 2.286 * L 1 - 2.57 * L 1 ) + 0.195 * A 1 * ( 1.93 * L 1 ) ( P 1 + P 2 ) - 0.73 * A 1 * P 1 * ( 0.7 * L 1 ) + 0.195 * A 1 ( 1.93 * L 1 ) P 4 - 0.73 * A 1 ( 0.7 * L 1 ( P 4 + P 2 ) \\ = - 0.286 * P 1 * A 1 * L 1 - P 2 * A 1 * L 1 - 0.29 * P 4 * A 1 * L 1 + 0.376 * A 1 * P 1 * L 1 + 0.376 * A 1 * P 2 * L 1 - 0.51 * A 1 * P 1 * L 1 + 0.376 * A 1 * P 4 * L 1 - 0.511 * A 1 * P 4 * L 1 - 0.511 * A 1 * P 2 * L 1 = \\ T = A 1 * L 1 ( - 0.42 * P 1 - 1.135 * P 2 - 0.42 * P 4 ) \qquad ( 18 )$$

Note. Result is worse than FIG. 5

Improved scenario:

FIG. 5

| | | |
|---|---|---|
| L7 = 2.625 * L1 | L8 = 2.44 * L1 | A4 = 0.14 * A1 |

T17=P2*0.14*A1*2.625*L1=0.3675*A1*P2*L1

T18=P1*0.14*A1*2.44*L1=0.34*A1*P1*L1

Developed Torque T

T=(16)+T17+T18=(−0.332*A1*L1*P1+0.311*A1*L1*P2)−0.71*A1*L1*P4+(0.3675*A1*L1*P2+0.34*A1*P1*L1)

−0.71*A1*L1*P4 Result is small, and can be disregarded.

In the best case scenario:

T=−0.008*A1*L1*P1+0.6785*A1*L1*P2

Unit is then feasible to operate CW

### Afterburner CCW

### FIG. 7

A1 Projected blade area
A2 Cutout rotor projected area
A3 Blade to rotor cutout area
A4 Back side blade area
P1 Combustor exhaust inlet pressure
P2 Expanded pressure
L1, L2, L3, L4, L5, and L6 Torque arm length
L4, L5, and L6 Fixed torque arm length

At the blades position as shown, toque values are:

T1 = P1 * A1 * L2
T2 = P2 * A1 * L2
T3 = P2 * A1 * L3
T4 = P1 * A1 * L1
T5 = P1 * A2 * L4
T6 = P2 * A2 * L4
T7 = P1 * A3 * L5
T8 = P2 * A3 * L5
T9 = P1 * A4 * L6
T10 = P2 * A4 * L6
Notes,
T7, T8, T9, and T10 cancel each other out.

Torque developed:

T=T1−T2+T3−T4+T5+T6

T=P1*A1*L2−P2*A1*L2+P2*A1*L3−P1*A1*L1+P1*A2*L4+P2*A2*L4

T=P1*A1(L2−L1)+P2*A1(L3−L2)+A2*L4(P1+P2) (19)

A2=0653*A1L2=2*L1L3=3.5*L1L4=1.125*L1

Substituting above values into (19)

T=P1*A1*L1+1.5*P2*A1*L1+0.734*A1*L1*P1+0.734*A1*L1*P2

Torque developed.

T=1.734*P1*A1*L1+2.234*P2*A1*L1

T=A1*L1(1.734P1+2.234P2) (20)

### Three-Stage Engine

### Summary

Total torque of three-stage engine torque developed by:

Compressor: A1*L1(1.425*P1−P4)=QT1 (5)

Combustor: A1*L1(1.43*P1+1.93*P2−1.07*P4)=QT2 (14)

Afterburner: A1*L1(1.734*P1+2.234*P2)=QT3 (20)

The average torque will be:

$$( QT 1 + QT 2 + QT 3 ) / 2 and HP = \frac{T * N * Z}{5252} * EFF .$$

Total

$$Hp = \frac{QT 1 + QT 2 + QT 3}{2} * N / 5252 * 4 * EFF .$$

Where QT1, QT2, and QT3 torque are in LBS.FT.

N=RPM (Revolutions per minute)

Z=Number of blades 4 cycles per revolution

EFF.=Total efficiency

Where:

P1 Combustor is much higher than P1 Compressor and P2 Combustor is higher than P2 Afterburner and P1 Afterburner is approximately P1 Compressor.

At the blades position, shown in the figures, with the appropriate pressures applied and the physical dimensions of each unit affected, which are all different. These equations are based on.
a. Compressor highest pressure
b. Combustor at ignition and combustion
c. Afterburner at highest inlet.

The results of the analysis presented are based on the sizes of the drawings shown. However, the analytical concept is applicable to any size of the single-stage and three-stage rotary internal combustion engine as described in this application.

What is claimed:

1. A Three-stage rotary internal combustion engine comprising:
a Compressor unit inspiring air intake, charging, and compressing fresh air; a Combustor unit receiving the compressed air from the Compressor unit for scavenge and compression; and having means for injecting fuel and igniting the highly compressed air resulting in the Combustor Rotor to be driven by the expansion of the combusted gases; an Afterburner unit receiving the combusted gases and scavenged air form the Combustor unit and having glow plugs for further burning resulting in the Afterburner Rotor to be driven by the expansion of the lean gases and furthermore expulsion of the lean gases; wherein each unit of the Compressor and Combustor and Afterburner further comprise: a cylindrical Housing consisting of two halves, bolted together, with side-walls having deep hemispherical grooves, wherein curved Blades inserted into cut-outs of the cylindrical Rotor, spaced ninety degrees apart and mounted to the Rotor by free rolling rods that are installed into drilled holes of the Rotor. The Blades are also outfitted with extended half round knobs on opposite sides of the top surface fitting into the deep hemispherical grooves, and are aligned within the Housing periphery.
A cylindrical Rotor, mounted in an eccentric position within the Housing and supported by the Housing's interior carrying walls, having a plurality if cut-outs and drilled holes, ninety degrees apart, to fit with precision the lower end of the curved Blades, which are installed with the free rolling rods captured in the drilled holes wherein the Housing halves deep hemispherical concentric grooves capture and guide the extended half round knobs of said Blades, while riding on the inside curvature of the Housing, to maintain said Blades in a self aligning extending and compressing position, wherein side surfaces of said compressing and extending movable curved Blades contact interior side-walls of the Housing and a top surface of said extending and compressing movable Blade is in permanent contact with the surface of the interior peripheral wall of the Housing; wherein the cylindrical Rotor of the Combustor is provided with a female and a male spline on both ends, the Compressor with a female slpine on one end, and the Afterburner with a male spline on one end to connect all Rotors on a common axis, and is also provided with a hollow core to allow oil flow for lubrication and cooling.

2. A Single-stage rotary internal combustion engine comprised of two egg-shaped Housing halves, bolted together, with side walls having deep hemispherical grooves, contoured as the Housing's egg-shaped internal periphery. It operates as the compressor and combustor. A cylindrical Rotor is mounted at the center position within the Housing and supported by the Housing's interior carrying walls. It has a plurality of cut-outs and drilled holes, spaced ninety degrees apart, to accommodate with precision the lower end of the curved Blades. The curved Blades have with free rolling rods captured in the drilled holes. The Housing halves' deep hemispherical egg-shaped contoured grooves capture and guide the extended half round knobs of the Blades and are aligned within the Housing periphery, while riding on the inside curvature of the Housing. The Blades maintain a self-aligning, extending and compressing position, wherein the side surfaces of the compressing and extending movable Blades are in permanent contact with the surface of the interior peripheral wall of the Housing. The Rotor is provided with a hollow core to allow oil flow for lubrication and cooling.

3. The Three-stage rotary internal combustion engine of the Blade type of claim 1, wherein the cylindrical Housing halves and the extending and compressing movable Blades, held in place by means of round shafts installed in the cut-outs of the cylindrical rotor, outfitted with extended half round knobs and guided and supported in deep hemispherical concentric grooves at the top end of the interior side-walls of the Housing are also applied for pneumatic or hydraulic rotary motors and pumping devices.

4. A Single-stage and Three-stage Rotary Internal combustion Engine comprise a blade configuration as shown in FIGS. 1, 4, 5, 6, 7 and 8, the extended half-round knobs and pin engagement methods to the blades (shown in FIG. 8), the rotor cut-outs and shaft attachment construction (shown in FIG. 9).
